(19) United States
(12) Patent Application Publication
(10) Pub. No.: US 2026/0097385 A1
(43) Pub. Date: Apr. 9, 2026

(54) COMPOSITE MATERIAL AND ITS USE IN PASSIVE COOLING

(71) Applicant: City University of Hong Kong, Kowloon (HK)

(72) Inventors: Steven Wang, Kowloon (HK); Wenzhu Lin, Kowloon (HK); Waikin Lo, Kowloon (HK); Qili Xu, Kowloon (HK); Zhenwen Zhang, Kowloon (HK)

(21) Appl. No.: 18/905,335

(22) Filed: Oct. 3, 2024

(51) Int. Cl. B01J 20/20; B01D 53/02; B01J 20/04; B01J 20/26; B01J 20/28; B01J 20/32; E04B 1/74; F25B 17/08

(52) U.S. Cl. CPC B01J 20/20; B01D 53/02; B01J 20/046; B01J 20/262; B01J 20/28011; B01J 20/2805; B01J 20/3204; B01J 20/3236; B01J 20/3272; E04B 1/74; F25B 17/08; B01D 2253/102; B01D 2253/202; B01D 2253/25; B01D 2257/80; B01D 2258/06

(57) ABSTRACT

A composite material for passive cooling includes a porous structure including an expanded graphite and a surfactant, the porous structure being provided with at least one crystalline deliquescent salt that is selected from the group consisting of chloride, bromide, sulphate, and nitrate. The uses of the composite material in passive cooling are also addressed.

### TECHNICAL FIELD

The present invention relates to a composite material, for example, particularly, but not exclusively, a composite sorbent material for passive cooling and use of the composite material in passive cooling applications.

### BACKGROUND OF THE INVENTION

It is believed that Earth's temperature has risen by ≈0.18° C. per decade since 1981 and year 2022 is the sixth-warmest year on record. As the Earth's temperature rises, cooling has become an essential aspect of our daily lives, especially in space cooling. Space cooling accounts for almost 40% of primary building energy usage, and the global demand is predicted to rise due to the occurrence of extreme heat events and higher living standards. Air compression-based air conditioners are the most used refrigeration devices for residential and industrial cooling. However, these devices consume a significant amount of energy and contribute to severe environmental pollution in carbon dioxide (CO₂) equivalents. Energy shortages are becoming more frequent, particularly in impoverished regions. The exploration of cooling strategies that operate with less energy consumption is thus highly desirable.

It is believed that cooling methods such as semi-passive and passive cooling methods are becoming popular in view of their high efficiency and energy savings as compared with electricity-driven vapor compression systems. Examples of such semi-passive and passive cooling methods may include radiative cooling, thermal sorption and the like. These methods, however, their cooling effectiveness/efficiency may be hindered by various factors/criteria such as low solar reflectivity and emissivity of the radiative materials, absorption of infrared radiation under high humidity climate conditions, etc.

Thus, there remains a strong need for an improved cooling strategy to eliminate or at least mitigate the aforementioned shortcomings.

### SUMMARY OF THE INVENTION

In a first aspect of the present invention, there is provided a composite material for passive cooling comprising a porous structure including an expanded graphite and a surfactant, the porous structure being provided with at least one crystalline deliquescent salt that is selected from the group consisting of chloride, bromide, sulphate, and nitrate.

Optionally, the porous structure comprises a scaffold of expanded graphite in which the surfactant and the at least one crystalline deliquescent salt are dispersed.

It is optional that the at least one crystalline deliquescent salt is dispersed in micropores of the scaffold of expanded graphite.

In an optional embodiment, the composite material further comprises a moisture-permeable material encapsulating the porous structure.

Optionally, the moisture-permeable material is liquid-impermeable.

It is optional that the moisture-permeable material is porous and has a pore size of about 3 μm.

Optionally, the moisture-permeable material is selected from the group consisting of PTFE, TPU and a combination thereof.

It is optional that the surfactant is selected from the group consisting of Triton X-100, IGEPAL CA-630 and a combination thereof.

In an optional embodiment, the surfactant and the expanded graphite has a mass fraction of about 1:10.

It is optional that the at least one crystalline deliquescent salt further comprises a counter cation selected from the group consisting of Li⁺, Na⁺, K⁺, Mg²⁺, Ca²⁺, Sr²⁺, Ba²⁺, Zn²⁺, Au³⁺, NH₄⁺, Fe³⁺, Cu²⁺, Co²⁺, Ni²⁺ and a combination thereof.

In an optional embodiment, the at least one crystalline deliquescent salt is selected from the group consisting of MgCl₂, CaCl₂, FeCl₃, LiCl, Cu(NO₃)₂, NaNO₃, LiNO₃ ZnSO₄, AuCl₃, NH₄Cl, ZnCl₂, CoCl₂, NiCl₂, SrCl₂, BaCl₂, CuCl₂ and a combination thereof.

Optionally, the at least one crystalline deliquescent salt is anhydrous.

In an optional embodiment, the composite material has a density of about 400 kg/m³ to about 600 kg/m³.

It is optional that the composite material is a sorbent material.

In a second aspect of the present invention, there is provided a composite sorbent material for passive cooling comprising a porous scaffold of an expanded graphite in which a surfactant and at least one deliquescent salt are dispersed; and a moisture-permeable material encapsulating the porous scaffold; wherein the at least one deliquescent salt is selected from the group consisting of chloride, bromide, sulphate, and nitrate.

Optionally, the at least one deliquescent salt is anhydrous and is provided in crystalline form.

In an optional embodiment, the surfactant comprises Triton X-100, the at least one deliquescent salt comprises LiCl, and the moisture-permeable material comprises PTFE.

In a third aspect of the present invention, there is provided an apparatus for passive cooling comprising: a housing including an inlet at one end and an outlet at another end; a plurality of passive cooling units provided within the housing, the plurality of passive cooling units is arranged to define an air passage fluidly connecting the inlet and the outlet; wherein the plurality of passive cooling units comprises the composite sorbent material in accordance with the second aspect of the invention.

Optionally, each of the plurality of passive cooling units includes a first end and a second end, and wherein the first end is in closer proximity to a lateral side of the housing with respect to the second end.

It is optional that each of the plurality of passive cooling units is arranged to partially overlap one another.

Optionally, each of the plurality of passive cooling units is arranged in parallel with respect to a vertical plane of the housing.

In an optional embodiment, each of the plurality of passive cooling units is configured as a block filled with the composite sorbent material.

Optionally, the block is made of a polymeric material selected from the group consisting of acrylic polymer, polyethylene terephthalate and a combination thereof.

In an optional embodiment, the air passage is a winding passage.

It is optional that the housing further includes a plurality of grooves configured to detachably secure the plurality of passive cooling units.

Optionally, the housing further includes a ventilation unit operably connected to the inlet, thereby allowing air to be drawn into the apparatus.

In an optional embodiment, the ventilation unit is a fan having a driving power substantially lower than cooling power of the apparatus.

It is optional that the inlet and the outlet are arranged on the same lateral side of the housing.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1 is a schematic diagram illustrating the top view of an apparatus for passive cooling in accordance with an exemplary embodiment of the present invention;

FIG. 2A shows the structure of a reference room used in the Examples of the present disclosure, the reference room is constructed by OSB and XPS board;

FIG. 2B shows the structure of a sorbent room used in Examples of the present disclosure, the sorbent channel was put above the sorbent room;

FIG. 2C shows a top view of the test system of the sorbent room;

FIG. 3 is a schematic diagram illustrating the one-story small office building used for modelling in EnergyPlus;

FIG. 4A is a table summarizing the building layers of the reference building;

FIG. 4B is a table summarizing the building layers of the building with sorbent cool roof;

FIG. 4C is a table summarizing the building surface information for energy saving assessment;

FIG. 4D is a table summarizing the wall material properties for energy saving assessment;

FIG. 4E is a table summarizing the wall construction materials for energy saving assessment;

FIG. 4F is a table summarizing the roof material properties for energy saving assessment;

FIG. 4G is a table summarizing the roof construction materials for energy saving assessment;

FIG. 5 is table summarizing the electricity emission factors from Ecoinvent database as per market for electricity;

FIG. 6 is a schematic diagram illustrating the sorbent material in accordance with an embodiment of the present invention supplying cold air to the indoor room;

FIG. 7 is a schematic diagram illustrating the working principle of the sorbent cooling system;

FIG. 8 shows the cooling power comparisons of the composite sorbent material in accordance with an embodiment of the present invention and reported methods;

FIG. 9A is a table summarizing the comparison of cooling power corresponding to FIG. 8;

FIG. 9B is a table summarizing the comparison of cooling power corresponding to FIG. 8;

FIG. 10 is a schematic diagram illustrating the synthesis route and the water contact angle of expanded graphite (EG) and the super hydrophilic expanded graphite (SHEG);

FIG. 11A shows the scanning electron microscopy (SEM) image of EG;

FIG. 11B shows the SEM image of EG, emphasizing its multiple inner layer structures;

FIG. 12 shows the SEM image of SHEG, emphasizing that the surfactant modification process did not destroy its inner porous structure;

FIG. 13 shows the appearance of EG and SHEG, indicating no significant change of appearance after the surfactant modification of expanded graphite;

FIG. 14A shows the SEM image of LiCl/SHEG and the corresponding EDS image, which indicates that LiCl crystals were distributed uniformly in the micropores of the SHEG matrix;

FIG. 14B shows the enlarged EDS image of LiCl/SHEG corresponding to FIG. 14A;

FIG. 15A shows the appearance of the shape-stabilized LiCl/EG and LiCl/SHEG blocks. All blocks were put into the same atmospheric air condition to absorb the water vapor, and test their mass and filter mass after 24 h, 36 h and 48 h to measure their water absorbed and water leakage mass;

FIG. 15B shows the water uptake and water leakage of different densities' LiCl/expanded graphite and LiCl/super hydrophilic expanded graphite blocks. The harvested water of 400 kg/m³, 500 kg/m³, and 600 kg/m³ LiCl/SHEG block after 24 hours was 1.02 g/g, 0.89 g/g, and 0.79 g/g, respectively, while the leaked-out water in filter is 0 g/g. Under the same circumstances, the LiCl/EG block could uptake 1.00 g/g, 0.84 g/g, and 0.72 g/g moisture for 400 kg/m³, 500 kg/m³, and 600 kg/m³ blocks, respectively, and the water leakage accounts for 0.35 g/g, 0.06 g/g and 0.03 g/g of the total absorbed water. After 36 hours, the leaked water of 400 kg/m³, 500 kg/m³, and 600 kg/m³ LiCl/SHEG block was 0.01 g/g, 0 g/g, and 0 g/g, while for LiCl/EG block was 0.14 g/g, 0.13 g/g, and 0.11 g/g, respectively;

FIG. 15C shows the leaking water in the filter of 400 kg/m³ LiCl/EG and LiCl/SHEG after 48 h, indicating that the SHEG matrix has better water adhesion performance;

FIG. 16 shows the water leakage performance after 24 h sorption of different densities' LiCl/expanded graphite and LiCl/super hydrophilic expanded graphite blocks;

FIG. 17 shows the water uptake performance comparison of LiCl, LiCl/EG, and LiCl/SHEG;

FIG. 18 shows the pore size distribution of super hydrophilic expanded graphite matrix and LiCl/super hydrophilic expanded graphite;

FIG. 19 shows the water uptake performance of LiCl/SHEG under different humidity with a constant temperature of 25° C.;

FIG. 20 shows the total water sorption capacity of LiCl/SHEG under different climate conditions;

FIG. 21 shows the total atmosphere water harvesting comparisons of the LiCl/SHEG and reported materials;

FIG. 22A shows the DSC and the thermogravimetric curves of the LiCl/SHEG;

FIG. 22B shows the DSC and the thermogravimetric curves of the LiCl/EG;

FIG. 23 shows the appearance of different densities' LiCl/super hydrophilic expanded graphite, indicating the block with density under 400 kg/m³ cannot be shape stabilized;

FIG. 24A shows the water uptake performance comparison of different densities' LiCl/SHEG blocks under the climate 25° C. and RH60%;

FIG. 24B shows the water releasing performance comparison of different densities' LiCl/SHEG blocks under 55° C.;

FIG. 25A shows the air permeability of the membrane. The petri dish with the anhydrous LiCl salt was carefully encapsulated by the PTFE membrane and put into the ambient for 24 hours. It clearly shows that the anhydrous LiCl absorbed the atmospheric water and turned into the solution, indicating the air can flow through the PTFE membrane, and the membrane has good air permeability performance;

FIG. 25B shows the water vapor permeability of the membrane. The petri dish with the LiCl solution was carefully encapsulated by the PTFE membrane and put into the heating pad temperature of 90° C. for 5 minutes. It clearly shows that the water was released out from the PTFE membrane and condensed into water droplets on the membrane and the cover, indicating the outstanding water vapor permeability of the PTFE membrane;

FIG. 25C shows the waterproofness of the membrane. The petri dish with the LiCl solution was put upside down for 24 h, and no solution was leaked out from the membrane, indicating the superior waterproofness of the PTFE membrane;

FIG. 26 shows the FTIR spectrum and water contact angle of the PTFE membrane;

FIG. 27 shows the water uptake performance comparison of LiCl/SHEG and PTFE encapsulated LiCl/SHEG blocks under the climate 25° C. and RH60%;

FIG. 28A shows the PTFE encapsulated LiCl/SHEG blocks before water absorbed;

FIG. 28B shows the PTFE encapsulated LiCl/SHEG blocks after 7 days of atmospheric water absorbed (T=23˜25° C., RH 65˜78%), the edge of the block was clearly filled by the absorbed water;

FIG. 28C shows that after removing the block, there is no water leak out to the petri dish, indicating the outstanding waterproof performance of the PTFE encapsulated LiCl/SHEG block even it has absorbed a high amount of water;

FIG. 29 shows the water sorption capacity of 400 kg/m³ PTFE encapsulated LiCl/SHEG blocks under different climate conditions;

FIG. 30 shows the photos and the corresponding SEM images of stainless-steel plate after seven absorption and desorption cycles. Left: the plate directly in contact with salt sorbent; Right: the plate directly in contact with PTFE membrane encapsulated salt sorbent;

FIG. 31A shows the photo of LiCl/SHEG block (left) and PTFE encapsulated LiCl/SHEG (right) directly contact with the stainless-steel plates before water absorption;

FIG. 31B shows the appearance of stainless-steel plates after seven absorption and desorption cycles. Left: the plate directly in contact with salt sorbent; Right: the plate directly in contact with PTFE membrane encapsulated salt sorbent;

FIG. 31C shows the SEM image of the stainless-steel plates directly in contact with LiCl/SHEG sorbent, indicating many holes were formed due to the salt corrosion;

FIG. 31D shows the SEM image of the stainless-steel plates directly in contact with PTFE encapsulated LiCl/SHEG, indicating the smooth surface of the plate, the salt solution was totally confined inside the membrane, avoiding the corrosion problem;

FIG. 32 shows the cycling performance of the PTFE encapsulated LiCl/SHEG blocks;

FIG. 33 shows the working cycle of the vapor sorption and desorption of the PTFE membrane encapsulated LiCl/SHEG sorbent;

FIG. 34 is a schematic diagram illustrating the experimental room of the sorbent room;

FIG. 35 shows the experimental setup of the reference room and sorbent room systems;

FIG. 36 is a schematic diagram illustrating the velocity and streamline distribution of the flowing air;

FIG. 37A shows the temperature comparison between the sorbent room and reference room when the climate is 40° C., RH45%;

FIG. 37B shows the temperature comparison between the sorbent room and the reference room under different temperature conditions;

FIG. 38 shows the temperature comparison between the sorbent room and the reference room under different humidity conditions;

FIG. 39 shows the weight loss profile of the sorbent room;

FIG. 40 shows the cooling power profile of sorbent room under different climate conditions and the comparison with radiative cooling;

FIG. 41 shows the cooling energy usage (kWh) for the reference building and the building with sorbent cooler;

FIG. 42 shows the energy savings for the reference building and the building with sorbent cooler;

FIG. 43A shows the comparison of the monthly distribution of cooling energy usage and energy savings in reference and sorbent cool roof buildings in Hong Kong;

FIG. 43B shows the comparison of the monthly distribution of cooling energy usage and energy savings in reference and sorbent cool roof buildings in Shanghai;

FIG. 43C shows the comparison of the monthly distribution of cooling energy usage and energy savings in reference and sorbent cool roof buildings in Mumbai;

FIG. 43D shows the comparison of the monthly distribution of cooling energy usage and energy savings in reference and sorbent cool roof buildings in Abu Dhabi;

FIG. 43E shows the comparison of the monthly distribution of cooling energy usage and energy savings in reference and sorbent cool roof buildings in Sydney;

FIG. 43F shows the comparison of the monthly distribution of cooling energy usage and energy savings in reference and sorbent cool roof buildings in New York;

FIG. 43G shows the comparison of the monthly distribution of cooling energy usage and energy savings in reference and sorbent cool roof buildings in Paris;

FIG. 43H shows the comparison of the monthly distribution of cooling energy usage and energy savings in reference and sorbent cool roof buildings in Sao Paulo;

FIG. 43I shows the comparison of the monthly distribution of cooling energy usage and energy savings in reference and sorbent cool roof buildings in Cape Town;

FIG. 44A shows the carbon footprint of cooling energy used in reference building and the building with sorbent cooler;

FIG. 44B shows the carbon dioxide mitigation potential in nine selected cities by using our sorbet cooler;

FIG. 45 shows a schematic representation illustrating the global heat waves in June and July 2022; and

FIG. 46 shows the simulated world map showing the sorbent cooling technology potential in annual cooling energy saving in different climate zones. (Note: energy usage was modelled in EnergyPlus and carbon footprint was simulated in SimaPro). Nine representative cities (Hong Kong, Shanghai, Mumbai, Abu Dhabi, Sydney, New York, Paris, Sao Paulo, Cape Town) from different zones were selected for comparison. This theoretical model implies that the proposed sorbent cooler can reduce annual cooling energy use by of 12.16% to 39% compared with predictions for nine cities with different climates and has the potential to cut down cooling energy carbon emission by 61% to 87.83% when compared to emissions released from cooling energy usage in reference building.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

It is believed that evaporative cooling is another energy-saving, energy-friendly, and environmental-friendly technique that could lower temperatures through phase transition of a liquid to vapor. However, it is believed that this technique would require an adequate or substantial amount of water supply for operation, which would be a challenge in regions such as impoverished regions which face severe water scarcity throughout the year.

Without wishing to be bound by theory, the inventors have, through their own research, trials, and experiments, devised a passive cooling strategy that makes use of ambient/atmospheric moisture/vapor for regulating temperature, in particular, indoor temperature substantially without additional energy input (i.e., with minimal energy consumption) and water consumption. In particular, it is devised that by using a composite material comprising an anhydrous salt and a surfactant-modified expanded graphite, such a composite material may absorb moisture from the air and subsequently release it during the day via evaporation to achieve cooling. In addition, without wishing to be bound by theory, the inventors have further devised that by providing a moisture permeable yet waterproof encapsulation to the composite material in some embodiments, it may prevent solution leakage and carryover, ensuring the cycling performance of the composite material.

In a first aspect of the present invention, there is provided a composite material, particularly a sorbent material, for passive cooling comprising a porous structure including an expanded graphite and a surfactant, the porous structure being provided with at least one crystalline deliquescent salt that is selected from the group consisting of chloride, bromide, sulphate, and nitrate.

In some embodiments, the porous structure may comprise a scaffold of expanded graphite in which the surfactant and the at least one crystalline deliquescent salt are dispersed. In particular, the at least one crystalline deliquescent salt may be dispersed in micropores of the scaffold of expanded graphite. It is believed that by dispersing, such as by way of impregnation, the at least one crystalline deliquescent salt into the porous structure, it may improve their water sorption characteristics while maintaining shape stability as well as enhancing heat and mass transfer ability of the composite material. It is also believed that a porous structure may have large pore volumes, high specific surface areas, and appropriate pore sizes that provide mass transfer channels and for loading the at least one crystalline deliquescent salt. Details of these characteristics will be demonstrated in the later part of the present disclosure.

The at least one crystalline deliquescent salt may be capable of absorbing moisture from air during night and release it during daytime, thereby achieving cooling by way of a liquid-to-gas phase transition. However, it is believed that hydrous salt may encounter issues such as solution carryover, swelling, and agglomeration. Without wishing to be bound by theory, the inventors have devised that this may be alleviated by using a breathable membrane that is capable of encapsulating the porous structure. It is believed that by encapsulating the porous structure with such a breathable membrane, it may reduce the risk of solution leakage and carryover, thereby ensuring the composite material's cycling performance.

In some embodiments, the composite material may further comprise a moisture-permeable material encapsulating the porous structure. The moisture-permeable material is particularly liquid-impermeable and porous. In some embodiments, the moisture-permeable membrane may have a pore size of about 3 μm (such as 2.85 . . . 2.87 . . . 2.90 . . . 2.94 . . . 2.98 . . . 3.00 . . . 3.06 . . . 3.15 μm and the like). In some embodiments, the moisture-permeable material is selected from the group consisting of PTFE, thermoplastic polyurethane (TPU) and a combination thereof.

The surfactant may be selected from the group consisting of Triton X-100, IGEPAL CA-630 and a combination thereof. It is believed that the hydrophilic modification of the porous structure with the surfactant described herein may ensure uniform absorption, high sorption kinetics, and shape stability, which will be demonstrated in the later part of the present disclosure. In some embodiments, the surfactant and the expanded graphite may have a mass fraction of about 1:10 (such as 1:9.5, 1:9.52, 1:9.7, 1:9.85, 1:9.9, 1:10, 1:10.1, 1:10.2 and the like).

In some embodiments, the at least one crystalline deliquescent salt may be anhydrous. The at least one crystalline deliquescent salt may further comprise a counter cation selected from the group consisting of Li⁺, Na⁺, K⁺, Mg²⁺, Ca²⁺, Sr²⁺, Ba²⁺, Zn²⁺, Au³⁺, NH₄⁺, Fe³⁺, Cu²⁺, Co²⁺, Ni²⁺ and a combination thereof. In other words, the at least one crystalline deliquescent salt may be a chloride salt, a bromide salt, a sulphate salt, or a nitrate salt of these counter cations. In some particular embodiments, the at least one crystalline deliquescent salt may be selected from the group consisting of MgCl₂, CaCl₂, FeCl₃, LiCl, Cu(NO₃)₂, NaNO₃, LiNO₃ ZnSO₄, AuCl₃, NH₄Cl, ZnCl₂, CoCl₂, NiCl₂, SrCl₂, BaCl₂, CuCl₂ and a combination thereof. In an example embodiment, the at least one crystalline deliquescent salt may be LiCl, particularly anhydrous LiCl. It is believed that anhydrous LiCl may have a highest water absorption capacity among various anhydrous salts, such as with a sorption capacity of 10.50 g/g at 90% relative humidity, which may therefore allow the composite material in accordance with this embodiment adaptable to a wide range of geographic regions as shown in the later part of the present disclosure.

Without wish to be bound by theory, it is believed that by stabilizing the shape of the composite material of the present invention, such as by way of compressing the composite material to a particular density, it may enhance the mass transfer rate of the composite material during the passive cooling process. In some embodiments, the composite material may have a density of about 400 kg/m³ to about 600 kg/m³, about 397 kg/m³ to about 600 kg/m³, about 397 kg/m³ to about 603 kg/m³, about 400 kg/m³ to about 603 kg/m³, about 400 kg/m³ to about 597 kg/m³, about 403 kg/m³ to about 600 kg/m³, about 403 kg/m³ to about 597 kg/m³ and the like.

Also pertained to the present invention is a composite sorbent material for passive cooling comprising a porous scaffold of an expanded graphite in which a surfactant and at least one deliquescent salt are dispersed; and a moisture-permeable material encapsulating the porous scaffold; wherein the at least one deliquescent salt is selected from the group consisting of chloride, bromide, sulphate, and nitrate.

In particular, the least one deliquescent salt may be anhydrous and may be provided in crystalline form. Yet in particular, the least one deliquescent salt may be those as described herein. In other words, the least one deliquescent salt of the composite sorbent material may be a chloride salt, a bromide salt, a sulphate salt, or a nitrate salt of the counter cations as described herein. In some embodiments, the at least one deliquescent salt may be selected from the group consisting of MgCl₂, CaCl₂, FeCl₃, LiCl, Cu(NO₃)₂, NaNO₃, LiNO₃ ZnSO₄, AuCl₃, NH₄Cl, ZnCl₂, CoCl₂, NiCl₂, SrCl₂, BaCl₂, CuCl₂ and a combination thereof.

In an example embodiment, the composite sorbent material as described herein may comprise a surfactant including Triton X-100, at least one deliquescent salt including LiCl, and a moisture-permeable material including PTFE. The surfactant of the composite sorbent material may have mass fraction with respect to the expanded graphite as described herein. The composite sorbent material may also have a density as described herein.

It is believed that the composite material or composite sorbent material as described herein may have the followings characteristics:
1. Passive Cooling without Additional Energy Input: Unlike conventional air conditioning systems that require significant electrical energy, the composite material or the composite sorbent material of the present invention relies on passive cooling through the natural processes of water absorption and evaporation, resulting in substantial energy saving.
2. Enhanced Water Sorption Performance: The use of anhydrous crystalline deliquescent salt such as anhydrous crystalline LiCl impregnated into a super hydrophilic expanded graphite (SHEG) matrix in the example embodiment may offer superior water sorption characteristics compared to existing desiccant materials. It is also believed that the hydrophilic modification and porous structure ensure uniform absorption, high sorption kinetics, and shape stability.
3. Prevention of Solution Leakage and Improved Durability: The encapsulation of the composite sorbent material in a breathable, waterproof membrane such as PTFE membrane in an example embodiment may prevent solution leakage and carryover, thereby enhancing the safety and durability of the composite sorbent material upon practical applications.
4. Higher Cooling Efficiency: In some embodiments, it is demonstrated the composite sorbent material may have significantly high cooling power, such as about 630 W/m², as compared to traditional radiative cooling methods that typically achieve around 160 W/m², suggesting the composite sorbent material of the present invention is more effective in reducing indoor temperatures, particularly in high-temperature climates.
5. Environmental Friendliness: In some embodiments, it is demonstrated that the system containing the composite sorbent material as described herein may be capable of providing adequate cooling capacity without additional water consumption, making it more sustainable and environmentally friendly than evaporative cooling systems that require a continuous water supply.
6. Adaptability to Diverse Climatic Conditions: In some embodiments, it is demonstrated that the performance of the system containing the composite sorbent material as described herein showing significant temperature drops and high cooling power over different climates (different temperatures and humidity). This adaptability makes it suitable for a wide range of geographic regions.
7. Reduced Risk of Health Hazards: By avoiding the issues associated with hydrous salts, such as solution carryover, swelling, and agglomeration, it is believed that the composite sorbent material as described herein may reduce the risk of harm to individuals inhaling the air, making it a safer option for indoor environments.
8. Cost-Effectiveness: By reducing the reliance on mechanical cooling systems and lowering energy consumption, it is believed that the composite sorbent material as described herein may offer potential cost savings in terms of both installation and operational expenses.

Accordingly, it is believed that the composite material or composite sorbent material as described herein are particularly suitable for passive cooling applications, such as being applied as an apparatus/device for indoor passive cooling.

In a third aspect of the present invention, there is provided an apparatus for passive cooling, comprising: a housing including an inlet at one end and an outlet at another end; a plurality of passive cooling units provided within the housing, the plurality of passive cooling units is arranged to define an air passage fluidly connecting the inlet and the outlet; wherein the plurality of passive cooling units comprises the composite sorbent material as described herein.

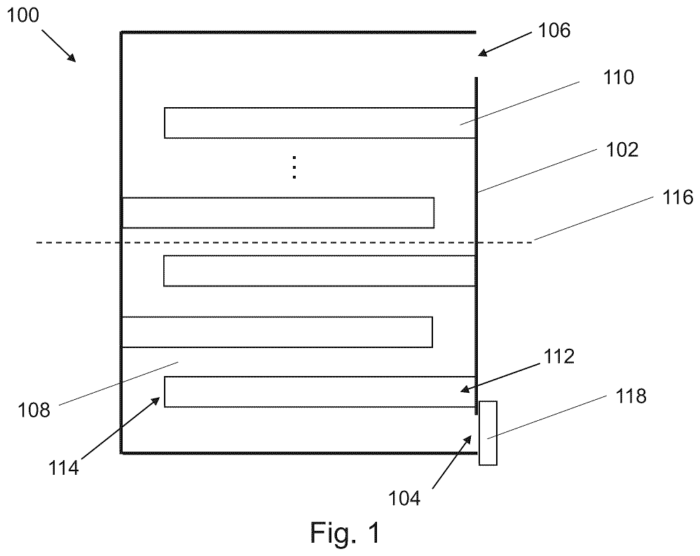

With reference to FIG. 1, there is provided an exemplary embodiment of an apparatus 100 for passive cooling. The apparatus 100 comprises a housing 102, which may be configured to various shapes or dimensions that fit practical needs. In this embodiment, the housing 102 is configured in a cuboid/rectangular prism. The housing has an inlet 104 at one end and an outlet 106 at another end. The inlet 104 and the outlet 106 may be arranged/configured in accordance with practical needs, such as being arranged/configured on the same lateral side or opposite sides of the housing. In this embodiment, as shown, the inlet 104 and the outlet 106 are arranged on the same lateral side of the housing 102.

The inlet 104 and the outlet 106 are fluidly connected by an air passage 108 defined by a plurality of passive cooling units 110 provided within the housing 102. The plurality of passive cooling units may be detachably secured to the housing via a plurality of grooves configured at the top and/or the bottom of the housing. Each of the plurality of passive cooling units 110 include a first end 112 and a second end 114, and wherein the first end 112 is in closer proximity to a lateral side of the housing 102 with respect to the second end 114. In particular, each of the plurality of passive cooling units 110 may be arranged to partially overlap one another. In this embodiment, each of the plurality of passive cooling units 110 is arranged in parallel with respect to a vertical plane 116 of the housing. In this way, a winding air passage 108 is constructed.

The plurality of passive cooling units 110 may be configured in various shapes or dimensions in accordance with practical needs. In this embodiment, each of the plurality of passive cooling units 110 is configured as a block filled with the composite sorbent material. The amount of composite sorbent material filled in the plurality of passive cooling units may vary in accordance with practical needs. In some embodiments, a total amount of about 200 g to about 300 g (such as 201 g to 304 g, 196 g to 304 g, 198 g to 304 g, 198 g to 301 g, 199 g to 302 g, 199 g to 299 g and the like) of the composite sorbent material may be used. The block may be made of a polymeric material selected from the group consisting of acrylic polymer, polyethylene terephthalate and a combination thereof.

To facilitate drawing air from the outside/exterior into the apparatus 100 for passive cooling operation, it is preferred to include a ventilation unit 118 configured at the inlet 104 of the housing 102. In particular, the ventilation fan 118 is operably connected to the inlet, thereby allowing air to be drawn into the apparatus. Yet in particular, the ventilation unit may be a fan 118 which may have a driving power substantially lower than the cooling power of the apparatus. For example, the driving power of the fan 118 may be at least 15 times lower than the cooling power such as from 15 times to 120 times lower than the cooling power achieved by the apparatus. Thus, it is believed that the apparatus as described herein is operated by way of passive cooling or substantially passive cooling.

Hereinafter, the present invention is described more specifically by way of examples, but the present invention is not limited thereto.

### EXAMPLES

### Materials and Methods

### Materials

99.995% pure lithium chloride, Triton-100, 80-mesh expanded graphite, and porous PTFE membranes are procured. Macklin was the supplier of lithium chloride (99.995%) and Triton-100 while the 80-mesh expanded graphite was provided by Tengshengda, China. Porous PTFE membranes were supplied by the New Polyfluorine material company, China. The super hydrophilic expanded graphite, the LiCl/super hydrophilic expanded graphite, and the PTFE membrane encapsulated sorbent are prepared as described below.

To prepare super hydrophilic expanded graphite, the expanded graphite was first dried in a vacuum oven for 12 hours at 100° C. to eliminate water. TritonX-100 was dissolved in ethanol and mixed well in a mass fraction of surfactant to expanded graphite of 1:10. The dry expanded graphite was added to the ethanol solution and dispersed ultrasonically for 20 minutes, repeated three times, and left to stand for 12 hours. The material was then collected by vacuum filtration and dried at 80° C. for 12 hours to remove ethanol, resulting in super hydrophilic EG.

To prepare LiCl/super hydrophilic expanded graphite (LiCl/SHEG), the hydrophilic expanded graphite was dried at 100° C. for 12 hours, then immersed in a 30 wt % LiCl solution and placed inside a vacuum chamber for 8 hours. Next, the LiCl/matrix was filtered to remove the extra salt solution. The collected material was then dried at 120° C. for 8 hours in a vacuum heating chamber to obtain the LiCl/super hydrophilic expanded graphite composite.

To create a PTFE membrane encapsulated sorbent, the prepared LiCl/matrix composite was pressed into a shape-stabilized block with a specific density. The block was then placed on the surface of a PTFE membrane with a 3 μm pore size and encapsulated carefully with high-temperature tapes.

### Material Characterization

A FEI Quanta 450 FEG SEM was used to capture SEM images and EDX mapping images. The specific surface area (BET) and pore volume were determined at 77 K using a Micromeritics ASAP 2020 apparatus and porosity analyser. Contact angles were measured via the sessile drop method with a 10 μL water droplet as the indicator and recorded with a digital camera (Basler, ace acA1300-200 μm). To measure the DSC and TG, we employed a Perkin Elmer Diamond DSC and kept the nitrogen flow rate constant at 50 mL/min. The infrared spectra were measured using a Fourier transform infrared spectrometer (Bruker Tensor 27 FTIR Spectrometer). We evaluated water sorption under constant RH and different temperatures using the constant temperature and humidity testing machine (QHP-150BE, LICHEN Technology, +0.1° C.; +2% RH) while recording the mass change of the sample using an electronic balance (YOUSHENG, 0.1 mg).

The water uptake and leakage performance of the different densities' LiCl/EG and LiCl/SHEG are calculated using the following equations:

$$water uptake = \frac{{m}_{water absorbed}}{{m}_{sample}} \qquad ( a )$$

$$water leakage = \frac{{m}_{water in fliter}}{{m}_{water absorbed}} \qquad ( b )$$

### Stability Test

Ten cycles of sorption-desorption were conducted to assess the cycling performance of the PTFE encapsulated LiCl/SHEG, using a shape-stabilized 400 kg/m³ block placed iF. The mass before and after each absorption/desorption cycle was measured using an electronic balance (YOUSHENG, 0.1 mg).

### Corrosion Test

To test the corrosivity of the PTFE encapsulated and non-encapsulated 400 kg/m³ LiCl/SHEG block, pure stainless-steel plates measuring 2 cm×2 cm were placed in direct contact with the sorbents. The plates were exposed to ambient conditions of 22° C. to 24° C. and 63% to 75% relative humidity for 23 hours, followed by heating on a hot plate at 120° C. for 1 hour to simulate working cycling.

### Fabrication of Sorbent Room Model

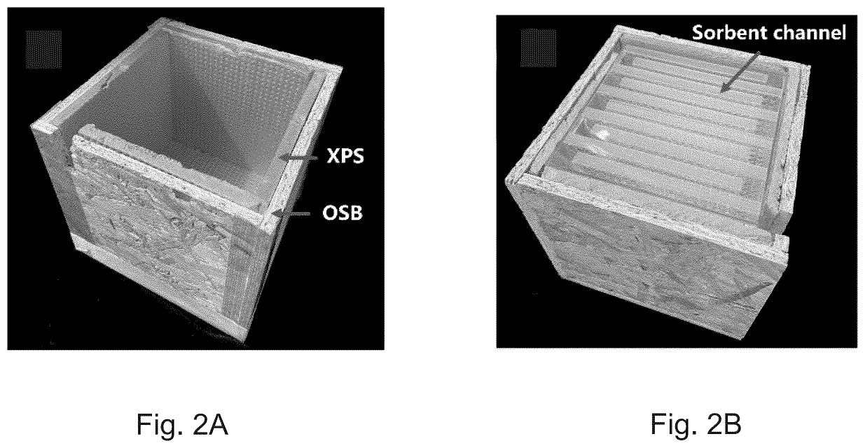

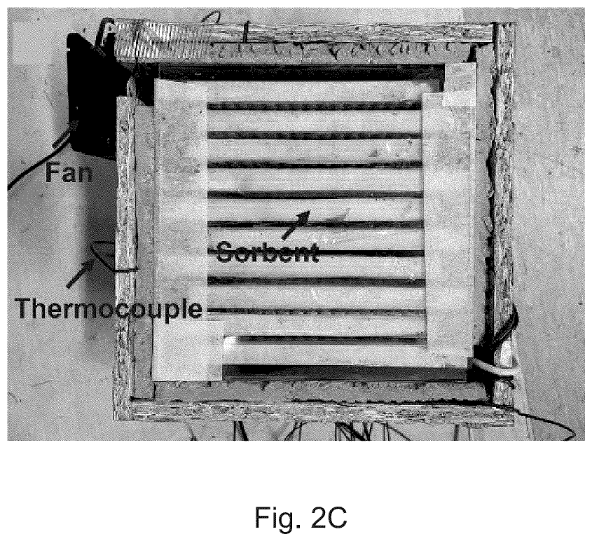

The sorbent room and the reference room were constructed using oriented strand board (OSB, thickness: 10 mm) and extruded polystyrene boards (XPS, thickness: 10 mm). OSBs are commonly used in building construction for wall sheathing, floor underlayment, and roof covers in both residential and commercial buildings. The XPS is a laminated insulating board that is safe, environmentally friendly, healthy, non-toxic, and moisture-proof. The experimental rooms' total dimensions are 200×200×200 mm, and the sorbent channel, which measures 160×160×50 mm, was made of acrylic board with a thickness of 2 mm. The bottom and top of the channel were designed with 1 mm thickness grooves to secure the shape-stabilized sorbent. Ten plates of encapsulated sorbents were integrated, measuring 138×48×8 mm, into the ventilation channel. A total of 212 g LiCl/SHEG was used, and the channel was placed directly above the room (FIGS. 2A-2C).

### Energy Saving Assessment

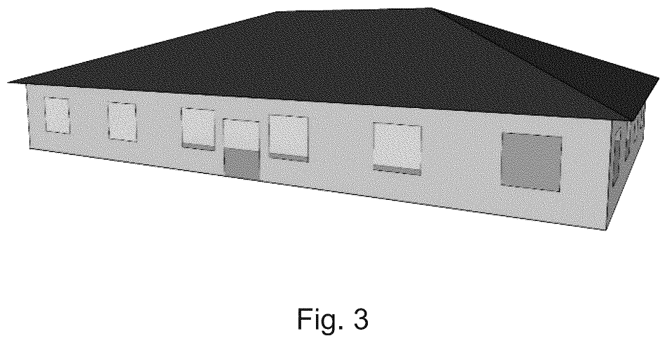

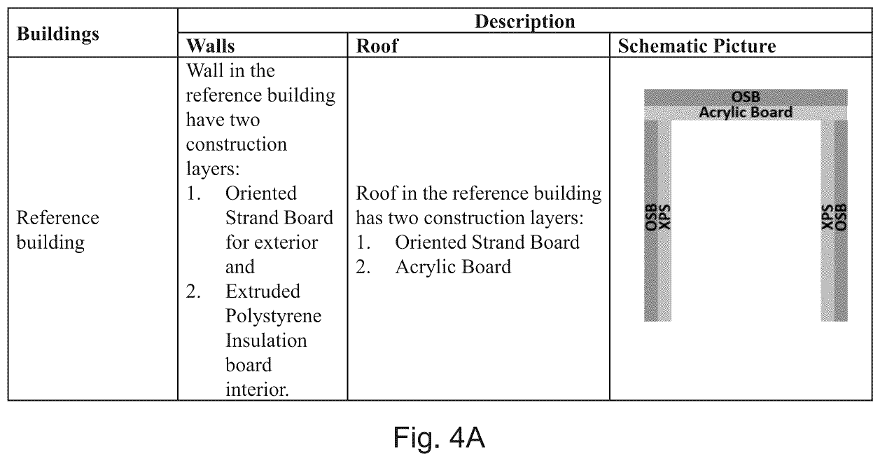

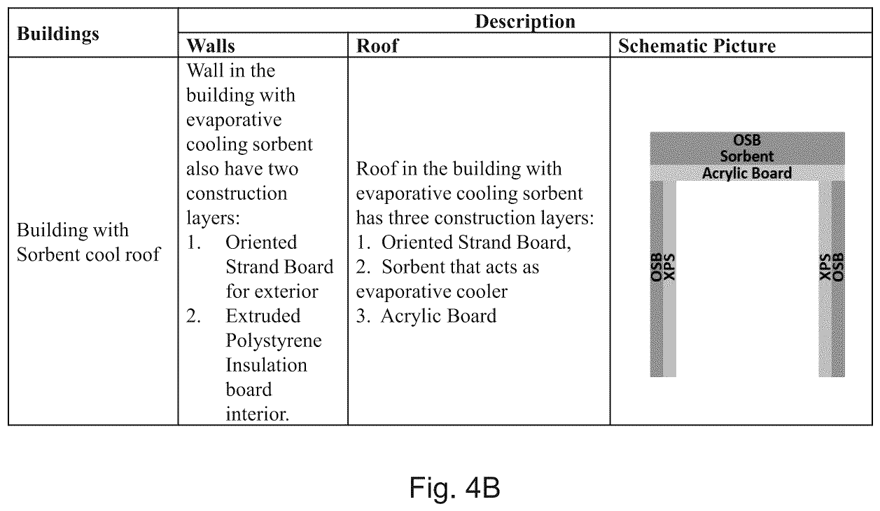

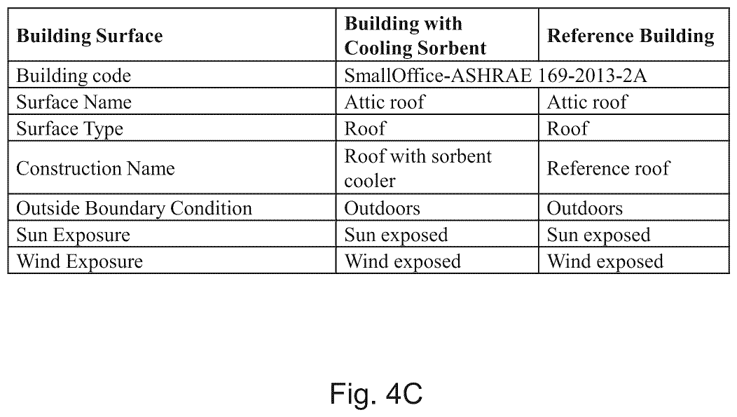

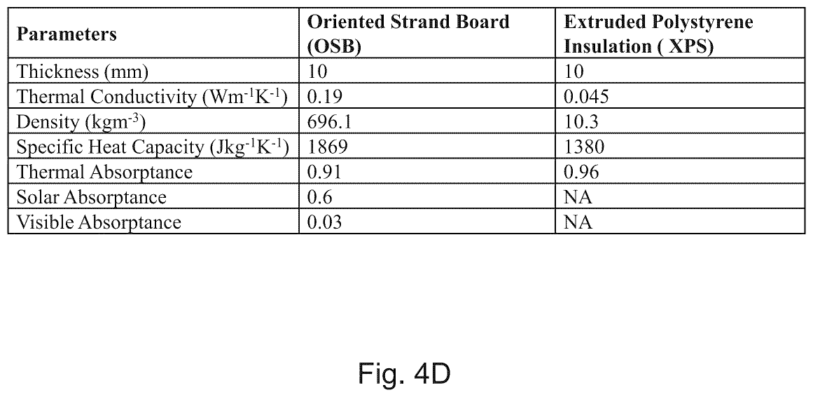

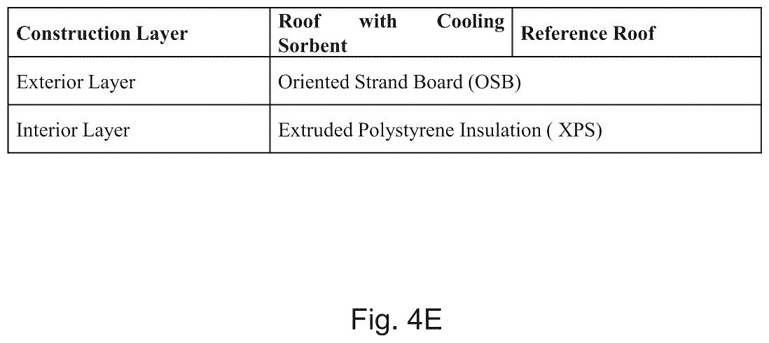

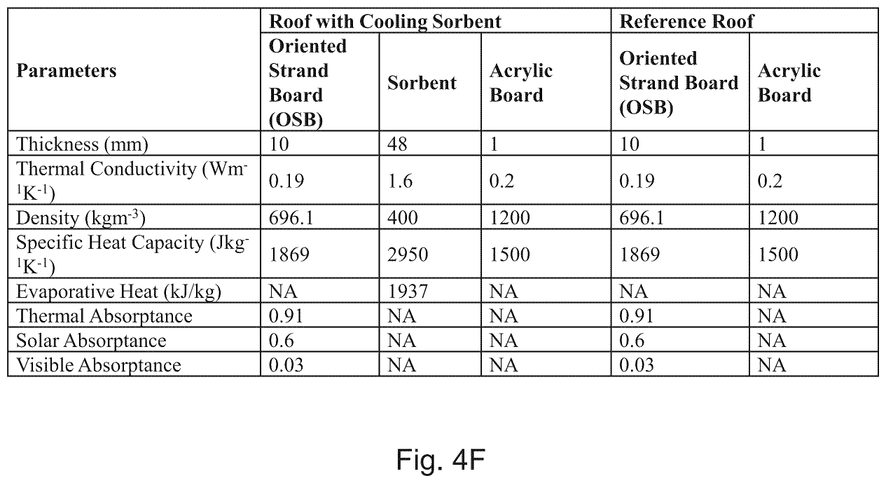

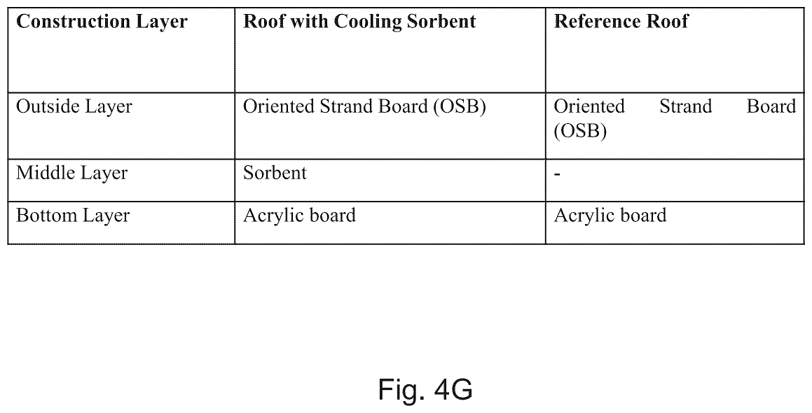

Building energy simulations in EnergyPlus are carried out to assess the energy performance and determine how this cooling technology would perform in varying climatic conditions. To achieve this, a one-story small office building that closely resembled real office facilities was selected and used as the basis for modelling a reference building and a building with a sorbent-based roof (FIG. 3). The ASHRAE code of the building was SmallOffice-ASHRAE 169-2013-2A. Details of the materials used for wall and roof construction in both buildings and their respective properties are provide in FIGS. 4A-4G.

Once the building designs were finalized, building energy simulations were performed on both buildings to estimate the variation in cooling energy use and energy-saving potential. Firstly, nine different cities with suitable weather files in .epw formats downloaded from EnergyPlus were selected. Then, extensive simulations were conducted to understand the energy-saving potential of a sorbent-based cool roof on a global scale. ArcGIS was used to visualize the energy-saving potential worldwide. To achieve this, a shapefile of the world map with climate zones attributed to shape area and shape length as a layer was added. A separate layer on energy-saving potential was created, based on the building energy simulations outputs, attributing to climate zones as in the shape file. Using the analysis command protocols in ArcGIS, the building energy simulations file futures to the shapefile for visualization were joined.

### Carbon Mitigation Potential Assessment

The environmental performance of the sorbent cool roof in comparison with a reference building under the building energy efficiency improvement standards is estimated by evaluating the carbon mitigation potential, see Eq. (c).

$$CMP = {GHG}_{en\_ref {\_roof}_{c}} - G H {G}_{en\_sorbent \_cool {\_roof}_{c}} \qquad ( c )$$

where GHG_{en_ref_roof}_{_{c}} is the greenhouse gas (GHG) emission due to cooling energy use in reference building in cities c that experience varying climatic conditions in tCO₂-eq.; GHG_{en_sorbent_cool_roof}_{_{c}} is the GHG emission due to cooling energy use in sorbent cool roof building in cities c that experience varying climatic conditions in tCO₂-eq.

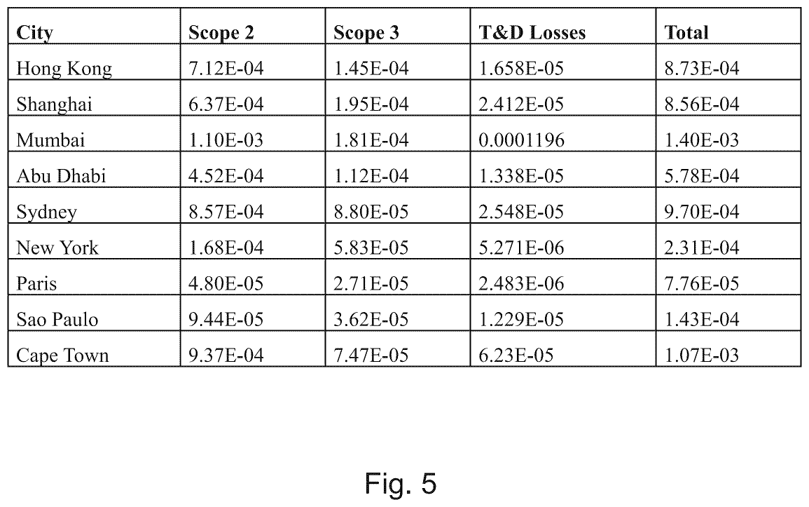

The GHG emission released due to cooling energy use in both reference and sorbent-based cool roof buildings are modelled by considering scope 2 (emissions that occurred out of the office building maintenance team control but as a result of electricity the office directly consumed from the grid) and scope 3 (emissions in the electricity supply chain of the grid) electricity emissions from the Ecoinvent database. Also, accounting for the practical situation that most office buildings are connected to the national electric grid in respective cities, the emissions released due to transmission and distribution (T&D) losses are considered. Eq. (d) represents the GHG emissions model used in this study to estimate the total GHG emissions. The electricity emission factors data of the nine selected cities can be seen in FIG. 5.

$${GHG}_{en\_building \_c} = \text{} {EleC}_{b u i l d i n g , c} \times ( Scope {2}_{ele , c , g} + Scope {3}_{ele , c , g} + T \& D {Losses}_{ele , c , g} ) \qquad ( d )$$

where GHG_{en_building_c} is the GHG emission due to electrical energy consumption (EleC) in the building located in city c; ele is the electricity mix accounting for both traditional and new forms of energy; g is the grid to which the building is connected in a given climate given multiple grid networks are available.

### Example 1

### Design and Working Principle of LiCl/SHEG

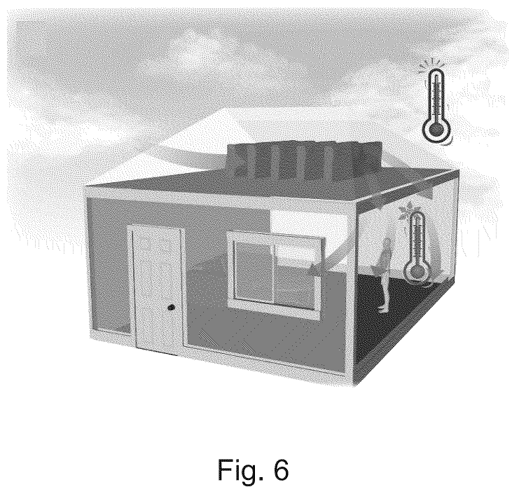

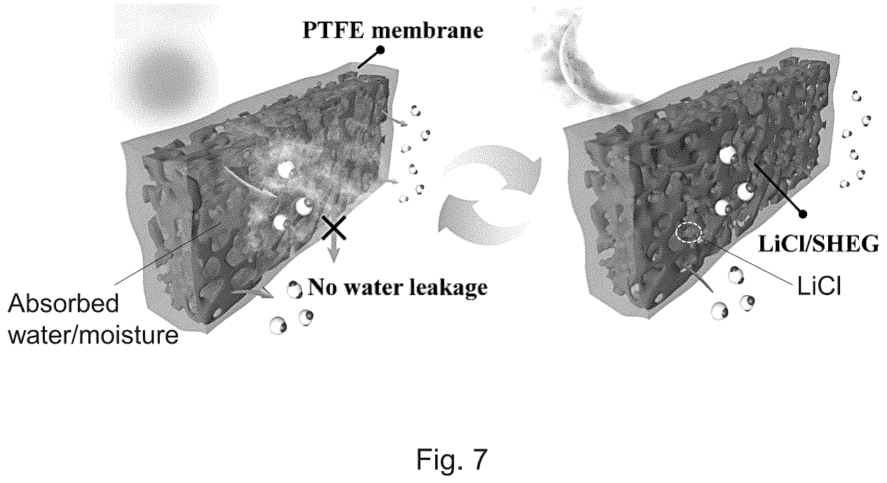

A sorbent cooler that can absorb moisture from the air during the night and release it during the day to achieve cooling has been developed (FIG. 6). The significant latent heat conversion achieves this cooling effect during the liquid-to-gas phase transition. As illustrated in FIG. 7, the sorbent absorbs atmospheric water; this absorbed water evaporates from the wetted sorbent absorbing heat and causing the air to leave the sorbent at a lower temperature. Although it is preferred that a constant airflow is required to facilitate the entire process; it is believed that the driving power of the constant airflow is much lower than the achieved cooling power, thus it can be considered passive. The high concentration of salt particles in the sorbent at night leads to a relatively low vapor pressure within the sorbent, allowing it to quickly absorb moisture from the surrounding air. The resulting cooling power can be calculated as follows:

$$P = \frac{H \times Δ m}{t \times S} \qquad ( e )$$

where H is the latent heat of vaporization of the liquid being evaporated, Δm is the weight loss of sorbent room due to the water evaporation, t is the test time and S is the surface area of indoor room.

The sorbent material chosen was the anhydrous salt LiCl due to its remarkable chemical stability, affordability, and exceptional water sorption capacity. In particular, LiCl could capture water molecules that are 5-6 times its weight and could have a capability of removing moisture from an atmosphere even in the very low humidity (up to RH 11.3%) condition. However, it is believed that hydrous salts may encounter issues such as solution carryover, swelling, and agglomeration, which pose a significant risk of harm to people inhaling the air. To tackle these problems, a porous matrix and a breathable but waterproof membrane were selected (FIG. 7). Impregnating hygroscopic salts, particularly deliquescent salt into porous materials may improve their water sorption characteristics while maintaining shape stability and enhancing heat and mass transfer ability. It is believed that porous matrices typically have large pore volumes, high specific surface areas, and appropriate pore sizes that provide mass transfer channels and load hygroscopic salts.

In this work, a hydrophilic modified expanded graphite with super hydrophilicity was prepared to improve water adhesion of the salt and alleviate agglomeration issues. Additionally, the sorbent was encapsulated with a porous PTFE membrane that is moisture permeable but waterproof, allowing airflow while preventing water leaks. As a result, the salt solution can be confined within the membrane, avoiding the risk of solution leakage and carryover, preventing the corrosive properties of the salt, and ensuring the sorbent's cycling performance.

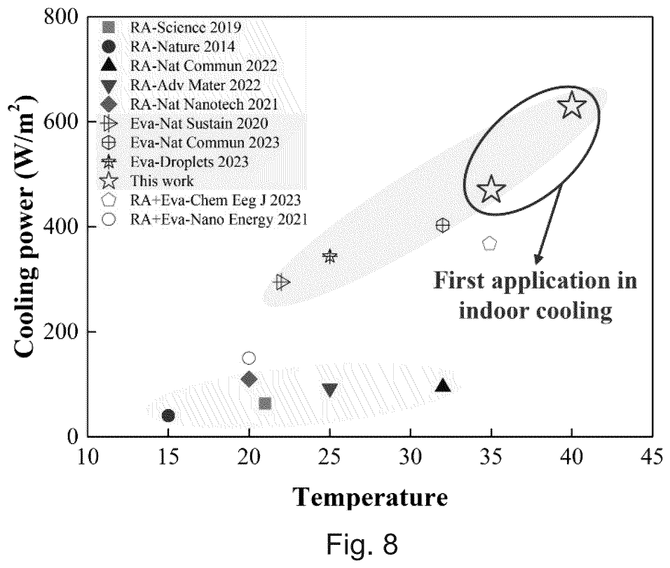

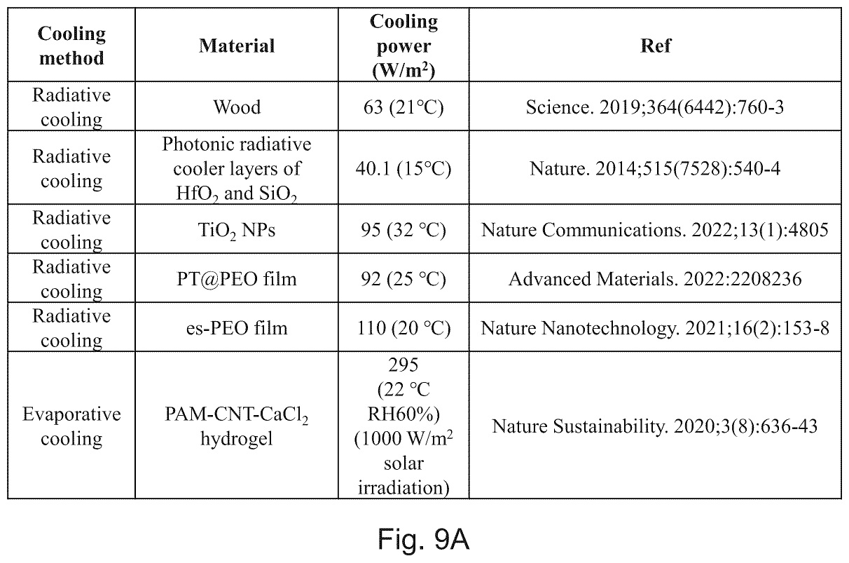

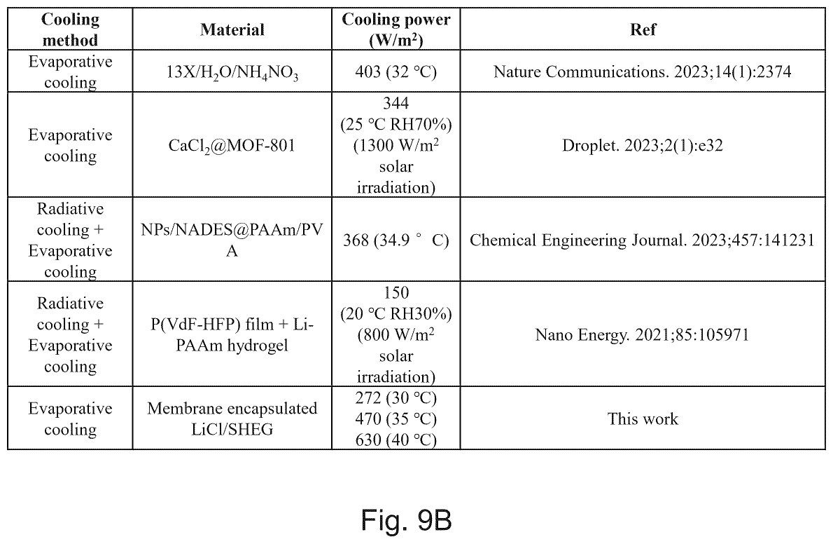

A comprehensive comparison was conducted to assess the cooling performance of the sorbent cooler of this work as compared with other reported cooling methods, including radiative cooling (RA), evaporative cooling (EVA) based on atmospheric water harvesting (which is believed to be similar to the cooling method of this work), and the combined method of radiative cooling and evaporative cooling (RA+EVA) (FIG. 8, FIGS. 9A and 9B). It can be seen from the figures that the cooling power of the sorbent cooler of this work outperforms radiative cooling in all circumstances. Furthermore, when compared to evaporative cooling based on atmospheric water harvesting, the cooling power achieved in this work demonstrates superior performance, particularly under higher temperature conditions.

Accordingly, it is believed that the cooling strategy of this work can provide effective indoor temperature regulation based on the atmosphere water harvesting (AWH) and evaporative cooling (EVA), which does not need to expose to the sun to achieve effective cooling (compared with radiative cooling).

### Example 2

### Characterization of LiCl/SHEG

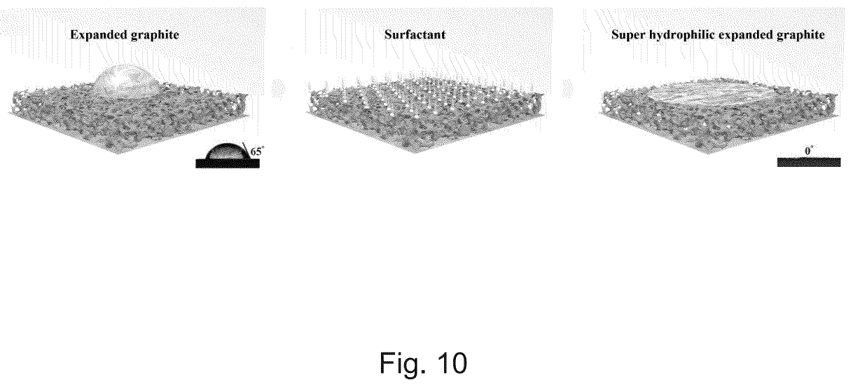

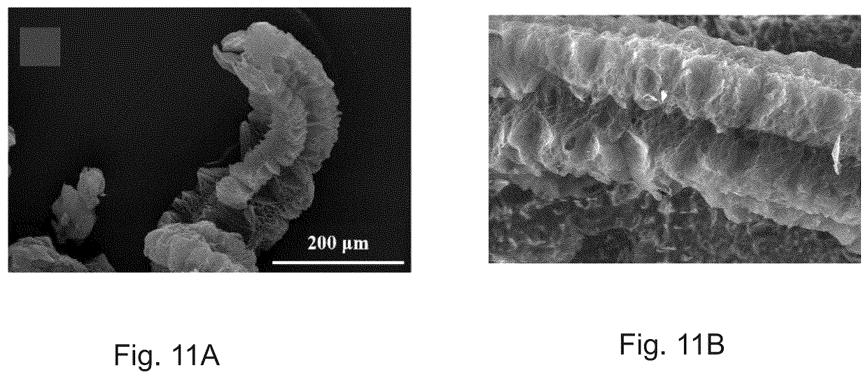

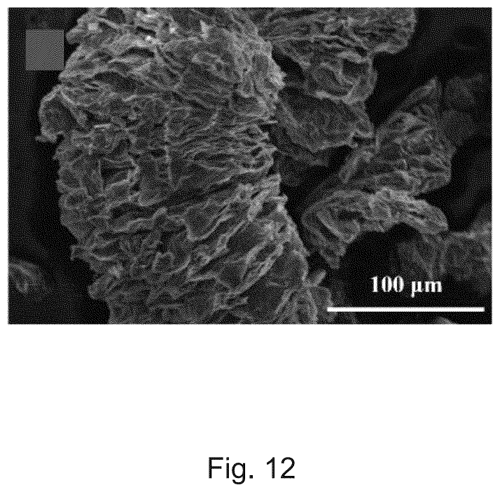

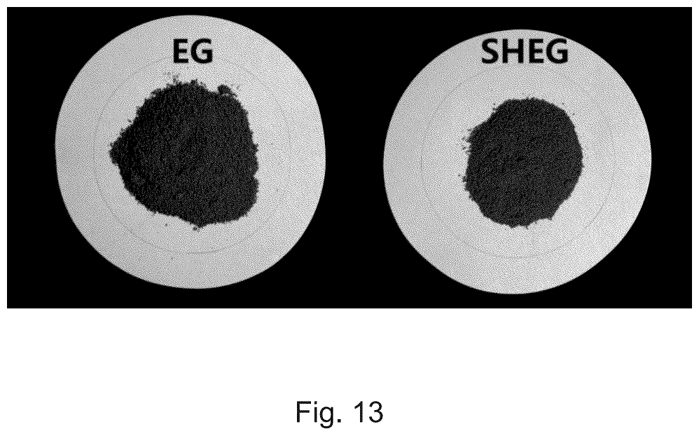

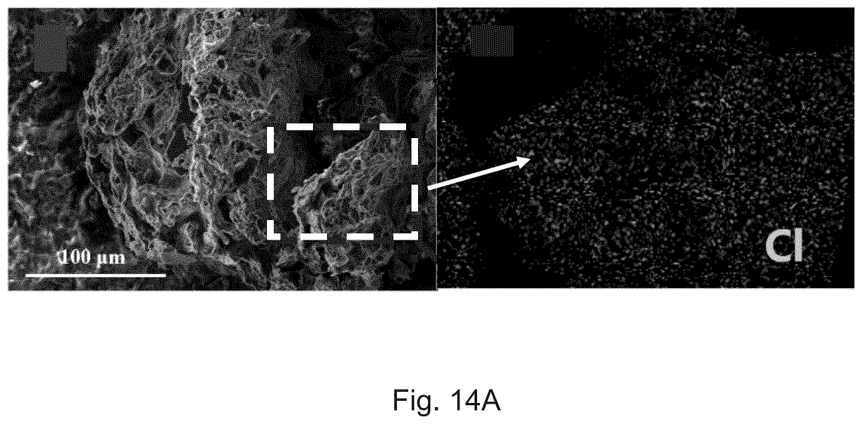

The expanded graphite (EG) was dispersed with the surfactant TritonX-100 using ultrasonic dispersion, thereby making the expanded graphite hydrophilic through a super hydrophilic modification. As depicted in FIG. 10, initially, the expanded graphite exhibited relatively poor hydrophilicity, with a contact angle of approximately 65°. However, after modification with TritonX-100, the super hydrophilic expanded graphite (SHEG) displayed a 0-degree water contact angle, indicating super hydrophilicity. The SHEG maintained its worm-like structure with multiple layers, as shown in FIG. 11A and FIG. 11B and retained its multiple-layer structure after modification (FIG. 12), with no change in appearance (FIG. 13).

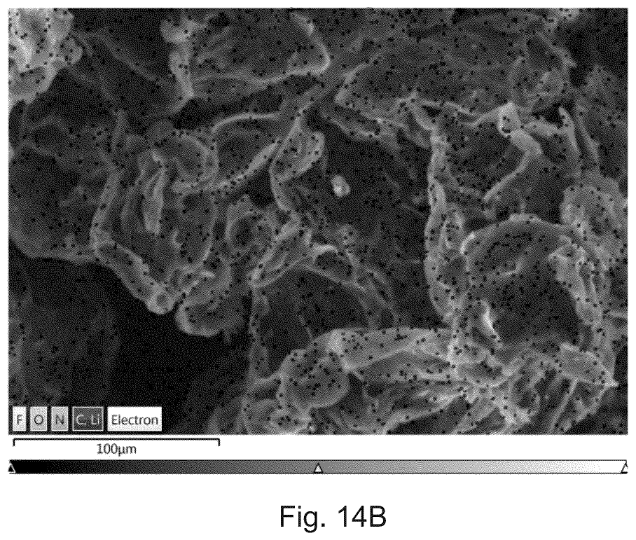

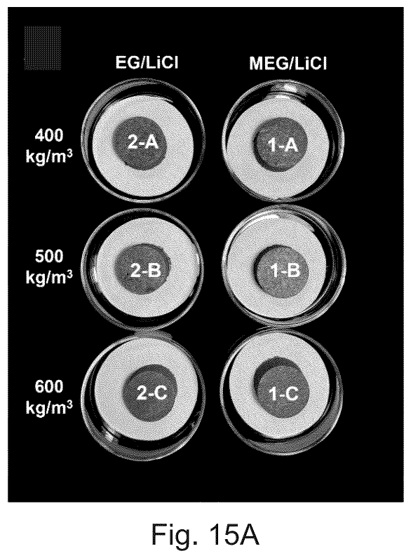

Vacuum impregnation technique was used to prepare the LiCl/SHEG composite, which is believed to be able to eliminate air from the matrix and increase the salt content. The uniform distribution of LiCl crystals on the surface of SHEG was evident in the SEM image and the corresponding energy disperse X-ray spectroscopy (EDS) element mapping (FIGS. 14A and 14B). The uniform distribution of LiCl crystals on the matrix increased the reaction areas, resulting in a faster rate of water vapor sorption. The strong hydrophilicity of SHEG made the matrix more conducive to water vapor sorption and mass transfer.

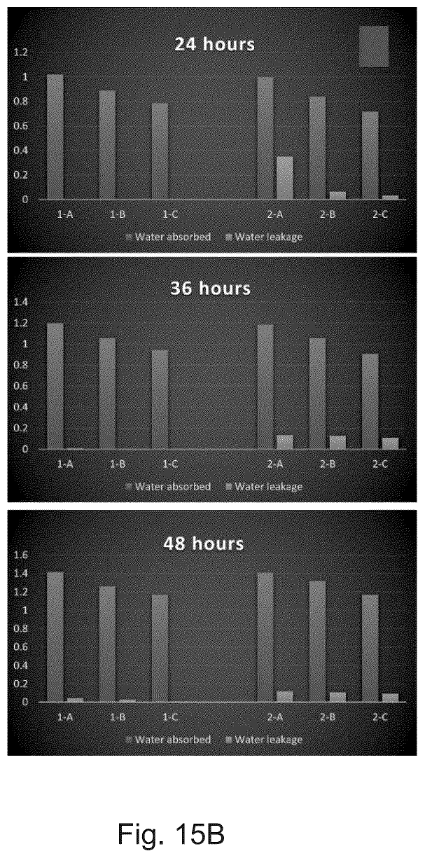

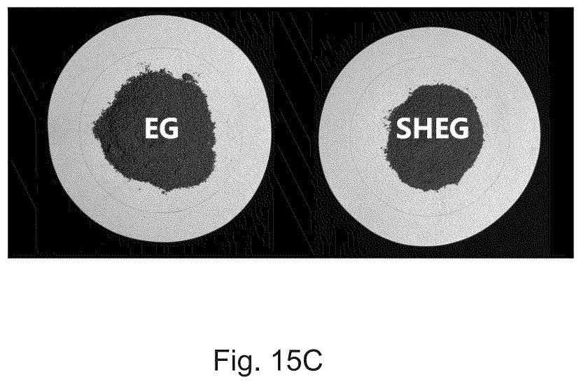

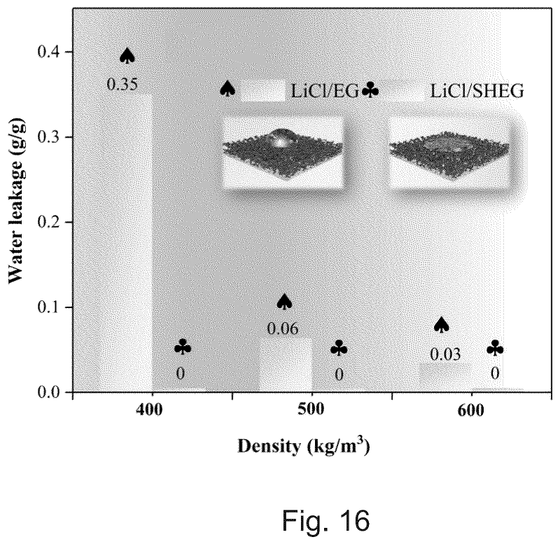

The moisture sorption performance of LiCl/EG and LiCl/SHEG is compared while maintaining the same mass fraction of salt load. LiCl composite blocks of varying densities were prepared and subjected to water vapor sorption and water leakage tests in the same air atmosphere. The mass change of the pressed LiCl composite in filter paper was monitored over time, and the results were presented in FIGS. 15A-15C. FIG. 16 illustrated the water leakage performance after 24 hours, which showed that LiCl/SHEG had much better water adhesion ability compared to LiCl/EG. For 400 kg/m³, 500 kg/m³, and 600 kg/m³ LiCl/EG blocks, the water leakage in filter paper accounted for 0.35 g/g, 0.06 g/g, and 0.03 g/g of the total absorbed water, respectively, while no water leaked out for LiCl/SHEG. The water stains in filters after 48 hours of sorption in FIG. 15C revealed that the leaked-out water of LiCl/EG was significantly more than that of LiCl/SHEG. Additionally, the harvested water of 400 kg/m³, 500 kg/m³, and 600 kg/m³ LiCl/SHEG blocks after 24 hours was 1.02 g/g, 0.89 g/g, and 0.79 g/g, respectively, while the LiCl/EG block uptake was 1.00 g/g, 0.84 g/g, and 0.72 g/g moisture for 400 kg/m³, 500 kg/m³, and 600 kg/m³ blocks under the same conditions, as shown in FIG. 15B.

The study indicated that LiCl/SHEG had greater water sorption and adhesion capacity due to the super hydrophilic ability of the SHEG matrix. It is believed that the hydrophilic functional groups of hydrophilic materials, such as polyethylene glycol (—OH), provided lone-pair electrons and vacancies that could bond with water vapor molecules through hydrogen bonds or electrostatic interaction. Therefore, hydrophilic materials' thermodynamic interaction with water is more favourable than that of hydrophobic materials.

### Example 3

### Water Sorption Performance of LiCl/SHEG

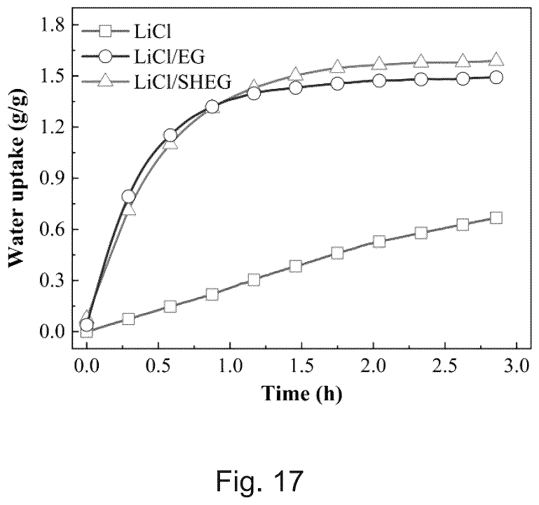

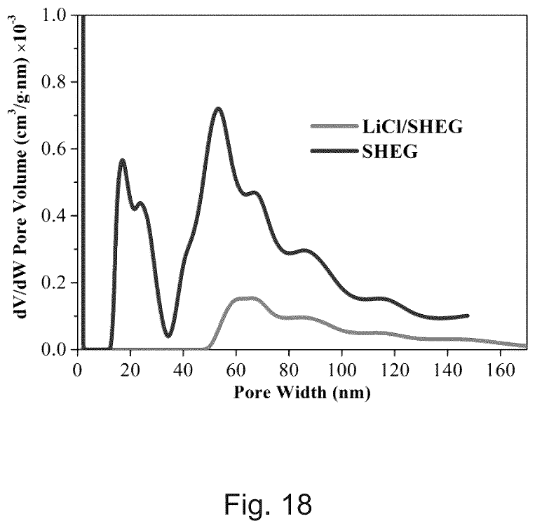

To assess the impact of a porous matrix on sorption performance, the dynamic sorption process of pure LiCl and its composite was measured. FIG. 17 depicts the sorption kinetics curves of LiCl, LiCl/EG, and LiCl/SHEG at a constant air condition of 25° C. and relative humidity of 60%. The results demonstrate that LiCl/SHEG and LiCl/EG exhibit significantly faster water sorption rates compared to pure LiCl. It is believed that this is due to the porous matrix providing pores and channels that increase the sorption interface area and support an enhanced mass transfer rate. This is evidenced in FIG. 18, the BET surface area of SHEG was found to be 14 m²/g, which is suitable for particle adsorption. Additionally, the porous structure of SHEG allowed the sorbent to penetrate the voids, porosity, and interlayer space. LiCl/SHEG exhibits a comparable dynamic sorption trend with LiCl/EG in the first hour and subsequently displays a slightly faster sorption rate than LiCl/EG. It is believed that this is because water's thermodynamic interaction with a super hydrophilic matrix is more favourable than its interactions with an expanded graphite with poor hydrophilicity.

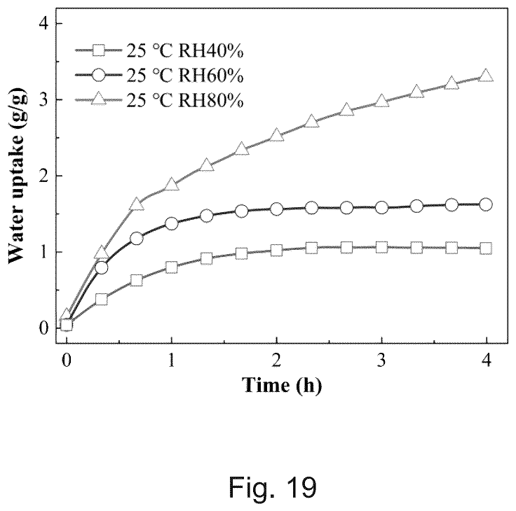

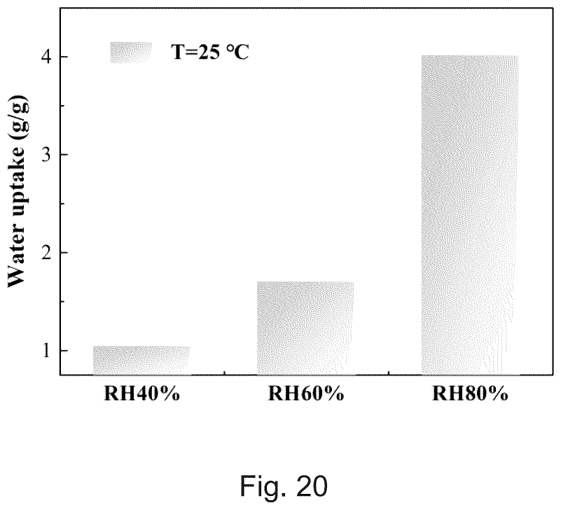

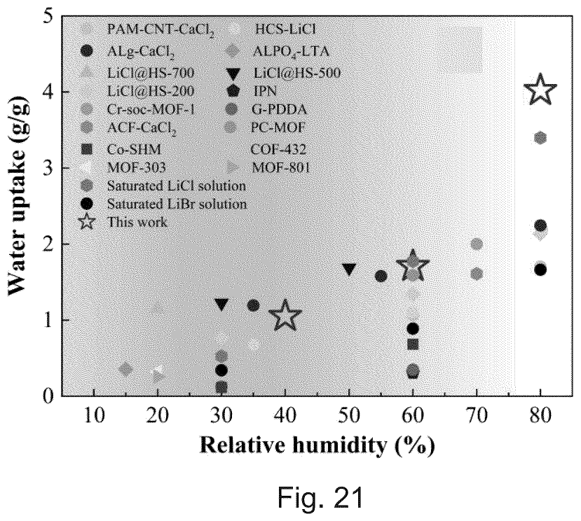

The moisture uptake performance of LiCl/SHEG at different humidity levels while the temperature remains constant at 25° C. is illustrated in FIG. 19. The results indicate that humidity plays a significant role in the sorption rate, with higher relative humidity levels resulting in higher sorption kinetics. FIG. 20 displays the final sorption capacities of the composite, indicating that LiCl/SHEG can harvest 1.06 g/g, 1.62 g/g, and 3.93 g/g atmospheric water at RH levels of 40%, 60%, and 80%, respectively. The total absorbed water vapor is much higher in a wet environment with higher relative humidity levels. Nevertheless, the sorption capacity can reach up to 1.06 g/g at lower humidity levels (RH 40%). These results indicate that LiCl/SHEG exhibits excellent moisture sorption performance and shows great water harvesting capacity in diverse environments. When compared with reported atmospheric water harvesting materials, LiCl/SHEG displays a higher sorption ability in arid regions (40% RH), semi-humid areas (60% RH), and high humidity (80% RH), as demonstrated in FIG. 21.

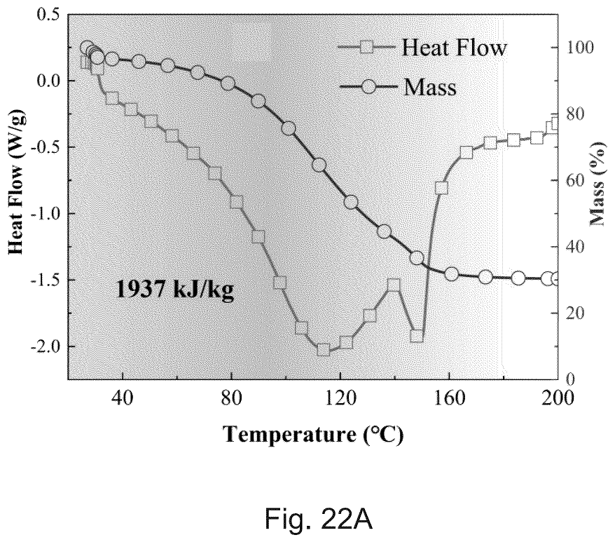

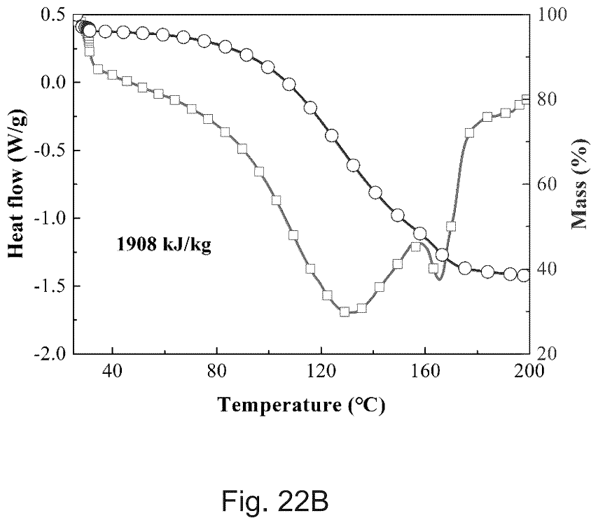

Differential scanning calorimetry (DSC) and thermogravimetric analysis (TGA) of LiCl/SHEG and LiCl/EG were performed to analyse their desorption performance, as shown in FIGS. 22A and 22B. The results indicate that the water-releasing process starts around 30° C., suggesting that the sorbent can release water under relatively low temperatures suitable for the evaporative cooling system. The total released thermo-chemical heat of the sorbent accounts for 1937 kJ/kg, indicating that the sorbent can store a large amount of energy for cooling purposes, demonstrating its superior performance in air cooling.

### Example 4

### Performance of the Membrane Encapsulated LiCl/SHEG

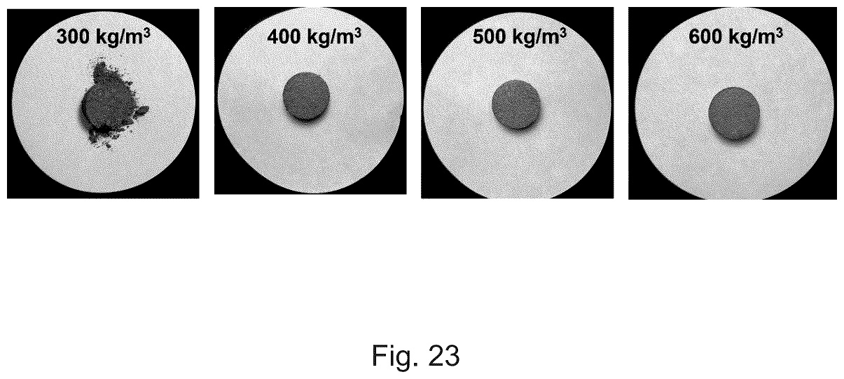

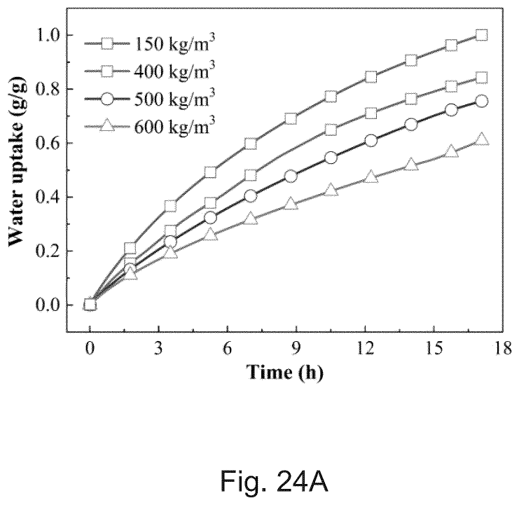

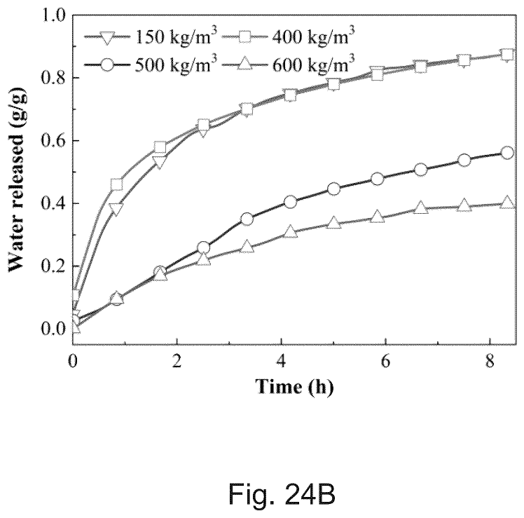

It is believed that shape-stabilized performance of sorbents is one of the important aspects in various application scenarios. Thus, the moisture sorption performance of a LiCl/SHEG block was investigated by pressing the sorbent matrix into a shape-stabilized block that could fit specific application requirements. As shown in FIG. 23, LiCl/SHEG blocks with a density of less than 400 kg/m³ could not maintain a fixed shape. The water absorption and release performance of sorbent blocks at various densities were demonstrated in FIGS. 24A and 24B, respectively, with an uncompressed LiCl/SHEG composite density of 150 kg/m³. The results showed that uncompressed LiCl/matrix had the highest sorption rate due to its extensive air contact area. However, higher compressed density led to reduced atmospheric water harvesting rate due to decreased heat transfer area. Similarly, the vapor releasing kinetics decreased gradually with improved compressed density. The LiCl/SHEG block with a density of 400 kg/m³ was selected for further investigation due to its overall performance, which included being shape-stabilized and maintaining fast kinetics for vapor sorption and desorption.

Deliquescent salts are a type of evaporative cooling material that exhibits superior water harvesting performance, but it is believed they may cause agglomeration and solution carryover issues that may be harmful to those who inhale the air. Without wishing to be bound by theory, the inventors have devised to confine the LiCl solution inside a PTFE membrane. It is believed that the porous PTFE membrane may provide excellent gas permeability, waterproofness, and strong chemical stability, thereby solving the problems of salt-solution leakage, cyclic sorption capacity reduction, and metal corrosion issues associated with salts.

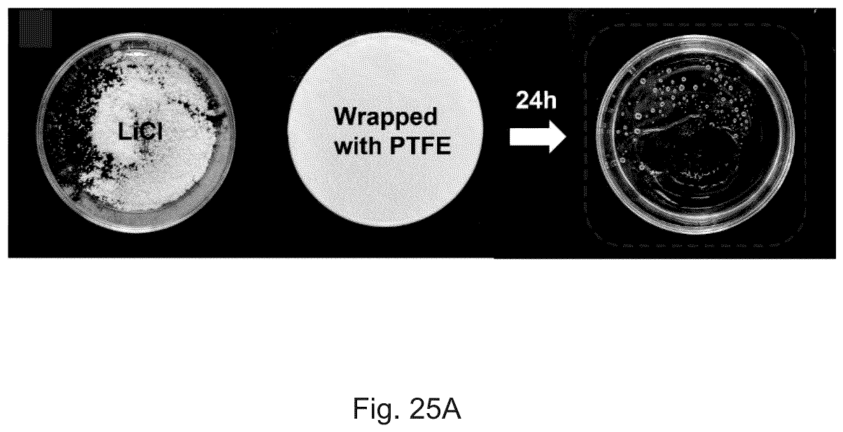

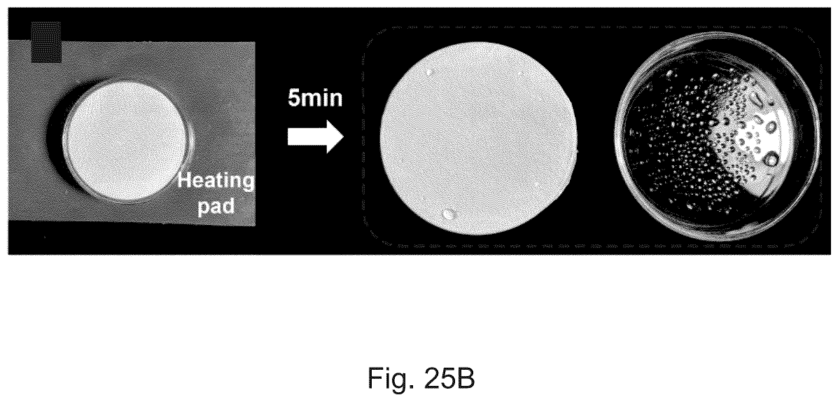

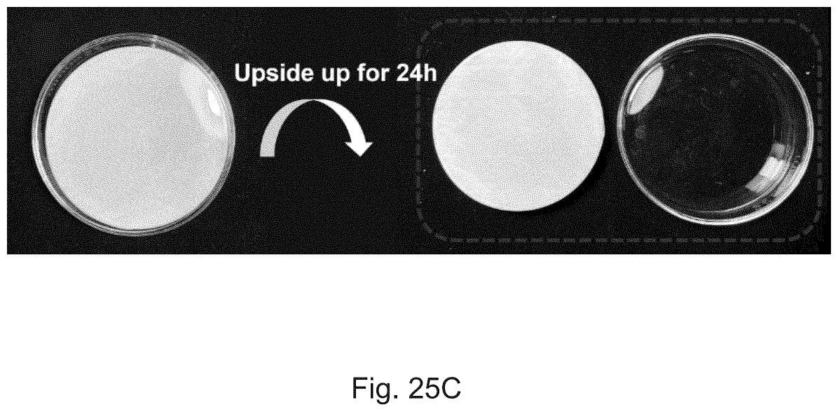

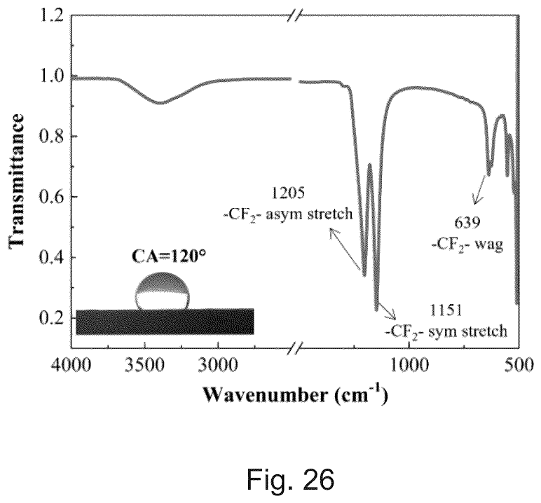

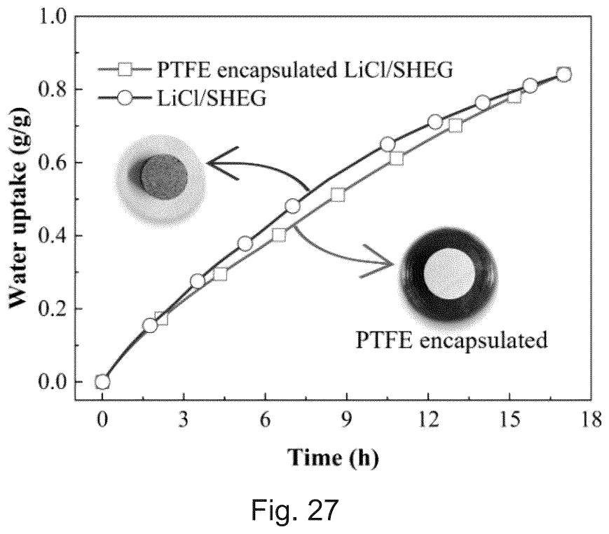

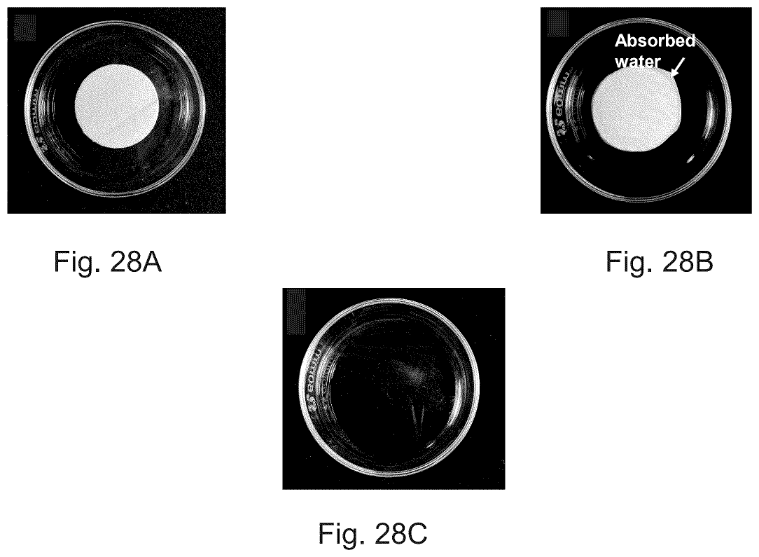

The LiCl/SHEG sorbent was pressed into a shape-stabilized block and placed on the surface of the PTFE membrane with pore sizes of 3 μm closely. The composite sorbent's side was carefully encapsulated with tapes. As shown in FIGS. 25A-25C, the breathable and waterproof ability of PTFE was confirmed, with a water contact angle of about 120°, indicating its outstanding hydrophobicity (FIG. 26). Moreover, the two characteristic peaks of PTFE target spectrum indicated its strong C—C bonds and C—F bonds, which also contributed to its hydrophobicity. The moisture sorption performance of LiCl/SHEG and the membrane-encapsulated LiCl/SHEG was compared (FIG. 27). As shown, the LiCl/SHEG had similar dynamic sorption trends with the PTFE encapsulated ones, indicating the excellent air permeability of the porous PTFE. Furthermore, the membrane-wrapped sorbent had superior waterproof performance. For example, after seven days of atmospheric water harvesting, the LiCl solution was well confined inside the membrane, with no signs of salt solution leakage (FIGS. 28A-28C).

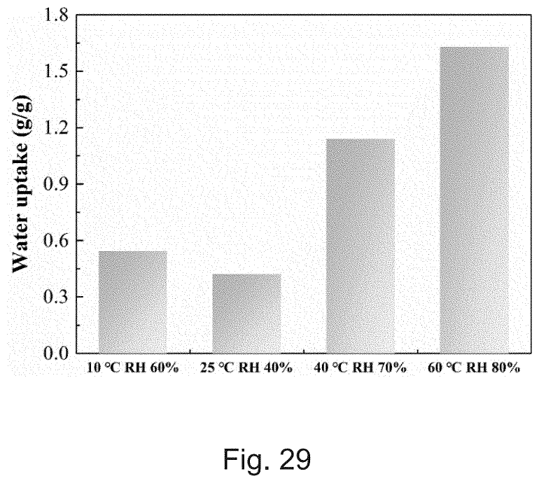

The water sorption capacity of the PTFE encapsulated LiCl/SHEG under different climate conditions is illustrated in FIG. 29. It is believed that, as a result of the excellent permeability and waterproofness of the membrane, the PTFE encapsulated LiCl/SHEG composite of this work combines the dual advantages of fast sorption kinetics of salt-based composite sorbents and superior water adhesion ability without any risk of solution leakage.

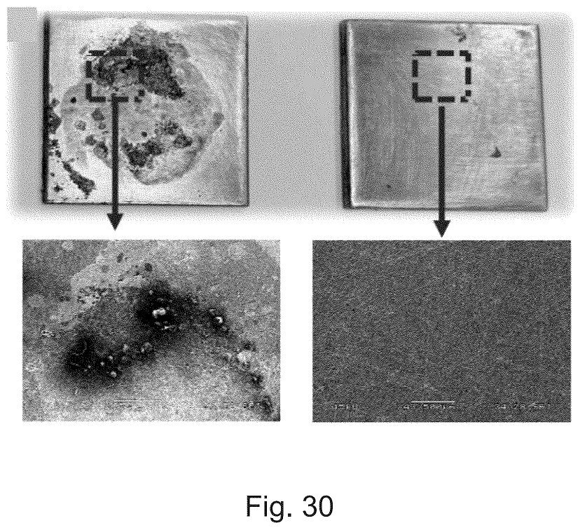

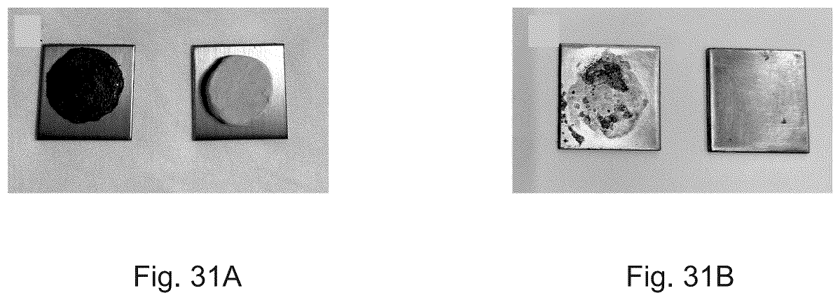

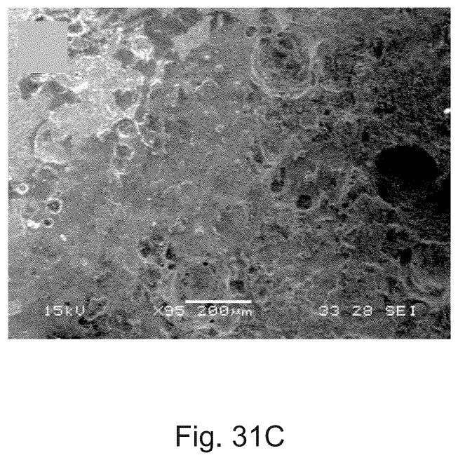

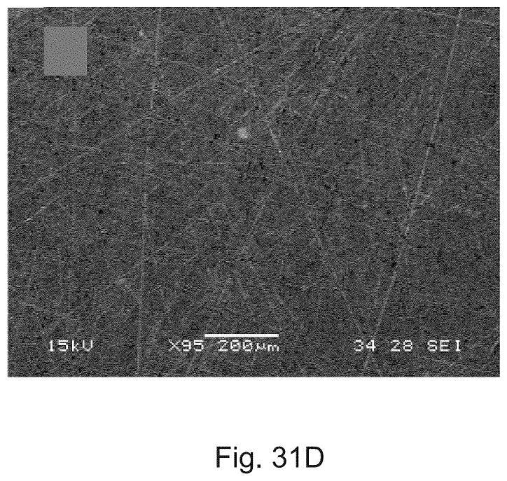

It is believed that the use of sorbents in cooling systems can be hindered by the corrosive effects of salt solutions on metal components. Without wishing to be bound by theory, it is believed that the PTFE encapsulated LiCl/SHEG composite as devised this work may be able to fully address this issue. To test the effectiveness of this approach, a corrosion test was conducted between the LiCl matrix and the encapsulated sorbent. The sorbent was in direct contact with stainless-steel plates during seven absorption and desorption tests. The results, depicted in FIG. 30 and FIGS. 31A-31D, revealed that the stainless-steel plate in contact with the non-encapsulated sorbent was severely corroded due to the presence of halide ions on metals. In sharp contrast, the plate in contact with sorbents encapsulated in membranes remained smooth after cycling, with no corrosion observed in the SEM figure. This indicates that the liquid containing halide ions did not leak through the PTFE membrane.

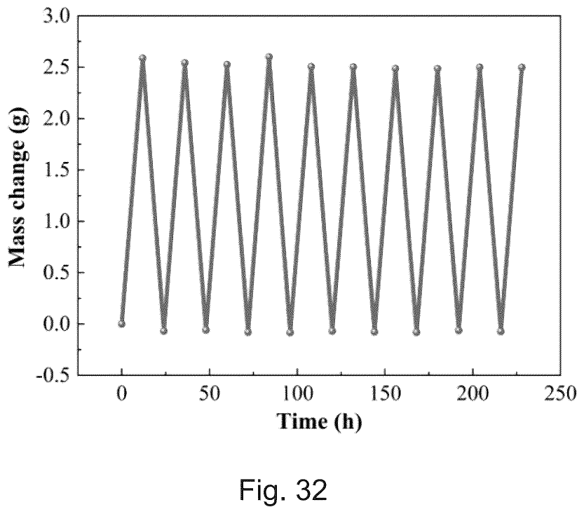

Moreover, the cycling performance of the membrane-wrapped LiCl/SHEG composite of this work was tested over ten absorption-desorption cycles. As shown in FIG. 32, no significant degradation in sorption performance was observed. This indicates excellent stability and reusability, which combined with the superior water sorption for a wide range of relative humidity, exceptional chemical stability, and corrosion prevention offered by the PTFE encapsulated LiCl/SHEG, provides significant potential for direct evaporative cooling, leading to cost and maintenance reductions.

### Example 5

### Cooling Performance of the Sorbent Cooler

To test the temperature change of the sorbent room and reference room under different climate conditions, both were placed inside a constant temperature and humidity chamber (QHP-150BE, LICHEN Technology, +0.1° C.; +2% RH). Two fans with a power of 0.8W were installed at the inlet boundary, and the flow velocity was measured by the TESTO 400. Nine temperature sensors were distributed at the top, middle, and bottom of the rooms, and the temperature data were collected using an Agilent data collector (34970A, Agilent), from which the average room temperature was calculated. The reference room was placed above an electronic balance (SAN JIANG, range 5000 g, 0.01 g) to record its weight loss over time. Both the sorbent room and reference room were placed inside the chamber with a climate of 25° C. and relative humidity of 60% for 12 hours to achieve the atmospheric water harvesting process. Then, they were moved to the test climate chamber to measure the evaporative cooling performance, and the temperatures of the two rooms and the sorbent mass change were recorded. The resulting cooling power is calculated as shown in Eq. (e).

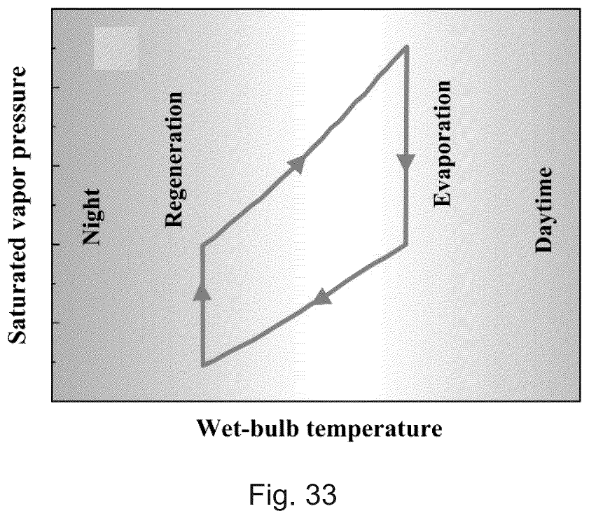

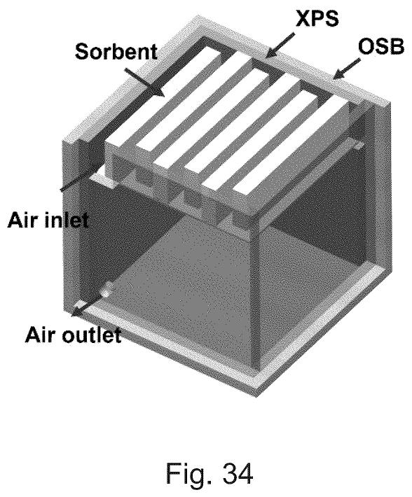

The operational concept of the sorbent evaporative cooling system is illustrated in FIG. 33. To examine the efficacy of the cooling sorbent concept, an experimental room was constructed and outfitted with the sorbent cooling system. The building model consisted of oriented strand board (OSB) and extruded polystyrene boards (XPS) each with a thickness of 10 mm, as illustrated in FIGS. 2A-2C and FIG. 34. Positioned directly above the room was a sorbent channel that held a rectangular block of super hydrophilic expanded graphite/LiCl sorbent with a density of 400 kg/m³. The sorbent was pressed to maintain a high mass transfer rate and shape stabilization. Ten plates of shape-stabilized PTFE membrane-encapsulated LiCl/SHEG sorbent were integrated into the ventilation channel. It is believed that the PTFE membrane encapsulated LiCl/SHEG material of this work would show excellent water adhesion, waterproofing, and shape-stabilization properties, enabling direct integration of the sorbent matrix into the building ventilation channel while avoiding water leakage and solution carryover.

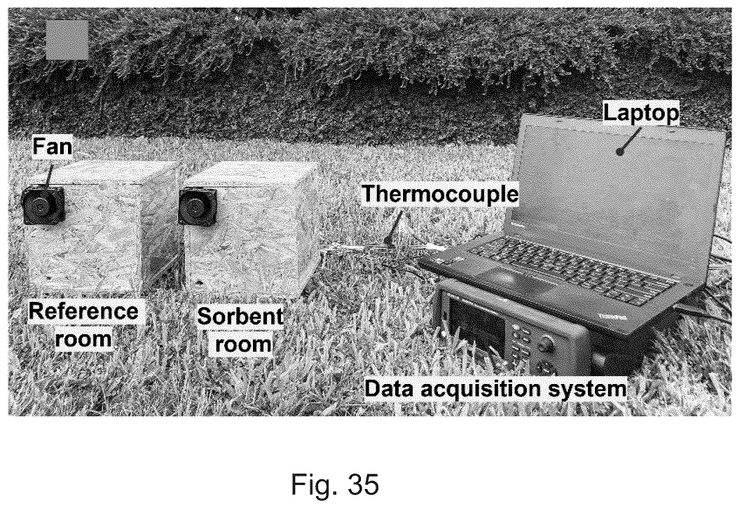

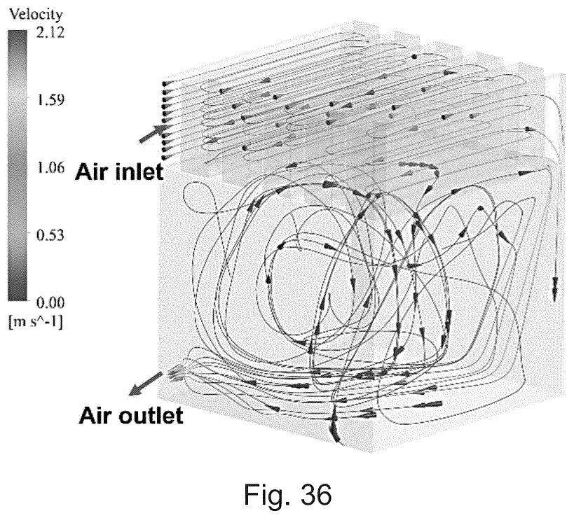

The experimental system was designed to test the system's application in diverse climatic regions, and a reference room without the evaporative cooling component was also set up to compare the cooling performance of the evaporative cooling rooms, as shown in FIG. 35. A small fan, with a working power of 0.8 W, was installed at the channel inlet to provide consistent airflow, and the airflow rate was maintained at 0.3˜0.4 m/s. The airflow distribution was simulated using Fluent software, as illustrated in FIG. 36. The airflow moved through the sorbent channel and circulated evenly in the indoor room before flowing out to complete the cooling process. To evaluate the indoor evaporative cooling performance of the processed experimental room model, it was placed in a constant temperature and humidity chamber. The experimental and reference rooms were subjected to different conditions, including three temperature settings (30° C., 35° C., and 40° C.) while the relative humidity was maintained at 45%.

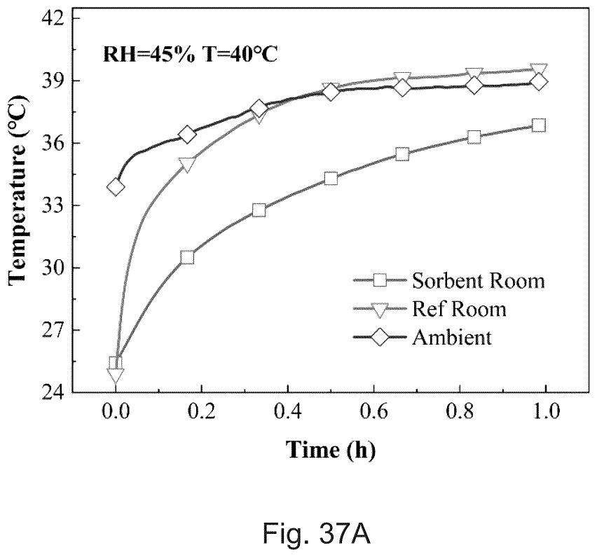

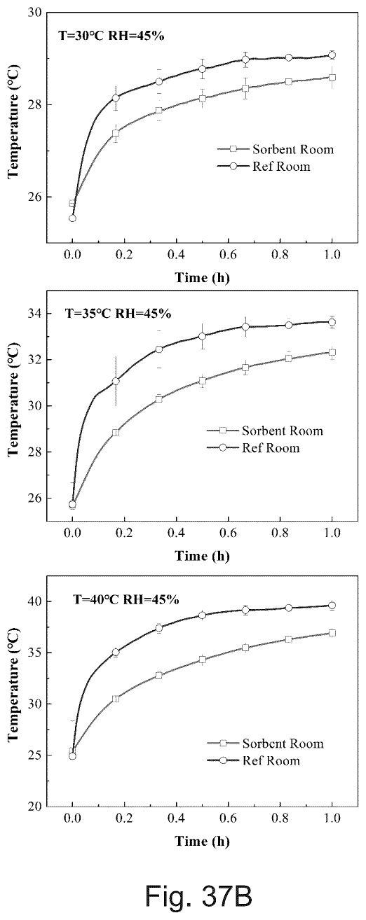

The temperature curves of the sorbent room and reference room at different temperature conditions were depicted in FIGS. 37A and 37B. As the exterior environment temperature increases to 40° C., the temperatures of both rooms increase gradually from the initial air temperature of 25° C. to the chamber temperature. However, the sorbent room exhibits a significantly lower temperature than the reference room. The evaporative ventilation system shows superior performance in higher temperature climates, with temperature drops of 0.6° C., 1.8° C., and 3.5° C. after one hour of operation when the ambient temperature is 30° C., 35° C., and 40° C., respectively. This temperature drop occurs due to the heat absorption of the sorbent, which absorbs the heat of the flowing air and reduces its temperature. The desorption process is more efficient in higher temperature climates, it is believed to be a result of improved kinetics, and the high thermal conductivity of the expanded graphite matrix which accelerates the heat transfer between the air and the sorbent, resulting in rapid air cooling.

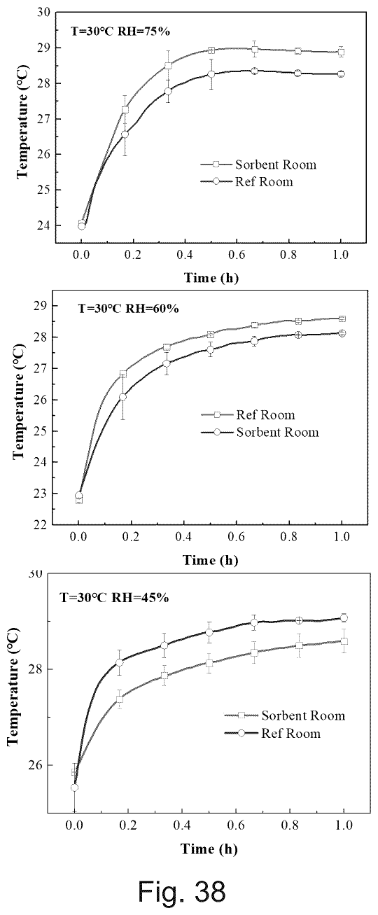

Additional experimental tests were conducted to explore the cooling performance under varying humidity conditions while maintaining a constant temperature of 30° C. As demonstrated in FIG. 38, it becomes evident that humidity also plays a crucial role in affecting the cooling performance. When the humidity is lower (RH 45%), the sorbent room experiences a temperature drop of 0.6° C. compared to the reference room after 1 hour of cooling. As the humidity level rises to 60%, the temperature in the sorbent room is 0.48° C. lower than in the reference room. It is worth noting that under relatively higher humidity conditions (RH 75%), after 1 hour of operation, the temperature in the sorbent room exceeds that of the reference room. This discrepancy arises from the fact that when humidity is high, the sorbent material remains in the absorption process. During the water harvesting phase, it releases heat, resulting in a slightly higher temperature in the sorbent room compared to the reference room. This observation suggests that this cooling method may be less suitable for regions with high humidity levels.

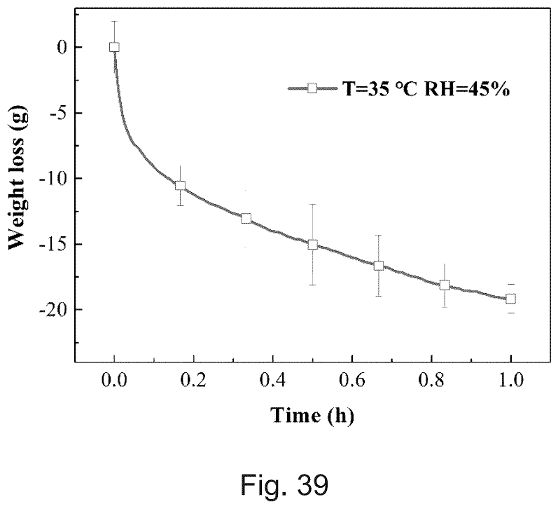

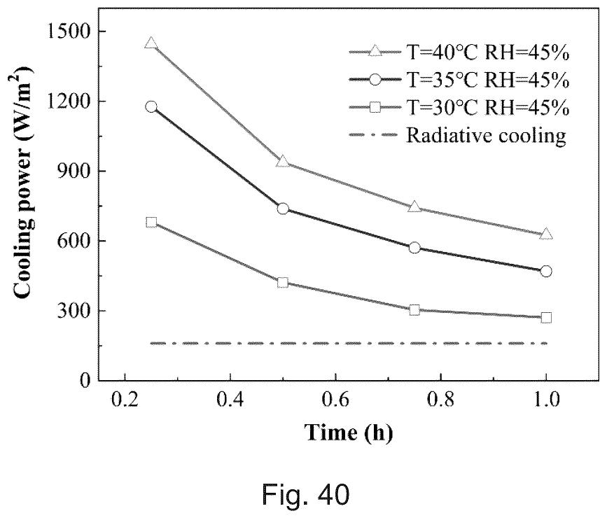

The weight loss profile of the sorbent cooler room (FIG. 39) indicates the amount of water evaporated during the test. The averaged cooling power was calculated using Eq. (e), where H is the enthalpy of vaporization of water (2450 J/g) and S is the surface area of the indoor room (0.0256 m²) in this work. The cooling power of the sorbent during the test is shown in FIG. 40. A high cooling power value is observed at the beginning of the test due to the large temperature difference between the ambient air and the sorbent room. As the test progresses, the cooling power gradually decreases but still exhibits a high cooling capacity even after one hour of operation. The cooling power reaches up to 630 W/m², 470 W/m², and 272 W/m² for climates of 40° C., 35° C., and 30° C., respectively, which is significantly higher than the radiative cooling power (depicted in FIG. 8) and 4 times higher than the theoretically highest power of radiative cooling (160 W/m²). The cooling power of the sorbent is higher with an increase in the outdoor temperature. These results demonstrate that the sorbent cooler of this work can provide adequate evaporative cooling capacity to an indoor room without any extra water consumption, thereby satisfying the space cooling demand and bringing better energy conversion performance.

### Example 6

### Energy Saving and CO₂ Mitigation Potential Assessment

Based on the above, it is believed that the sorbent cooler of this work may be able to combat the rising frequency and intensity of heat waves worldwide. As a proof of concept, studies have been performed to understand how well the cooling strategy of this work performs under varying climatic conditions if integrated into a real-time building as per the ASHRAE standards, from both energy savings and carbon dioxide mitigation potential point of view.

A one-story small office building that closely resembles an actual office facility was modelled in EnergyPlus (refer FIG. 3 and FIGS. 4A-4C for schematic view and construction material layers) and leveraged in nine cities, including Hong Kong, Shanghai, Mumbai, Abu Dhabi, Sydney, New York, Paris, Sao Paulo, and Cape Town that experience different climates and has a distinct electricity emission (as depicted in FIG. 5) based on the energy mix.

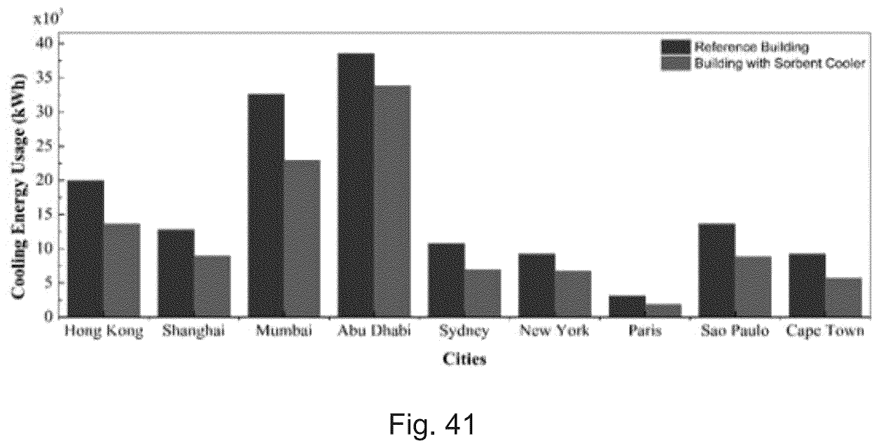

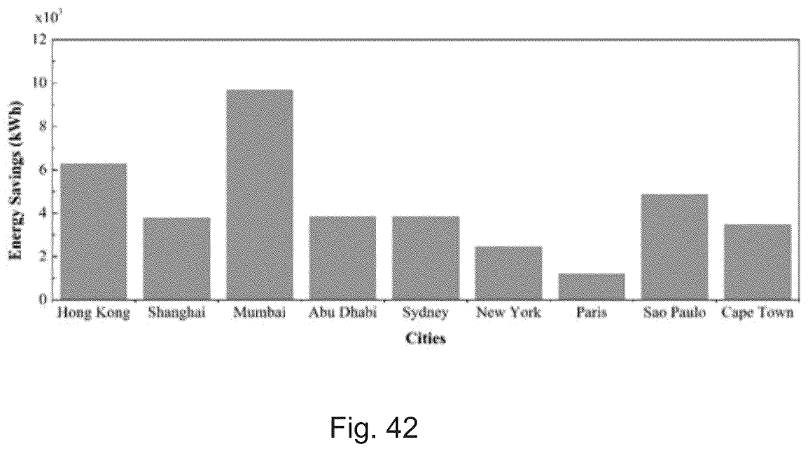

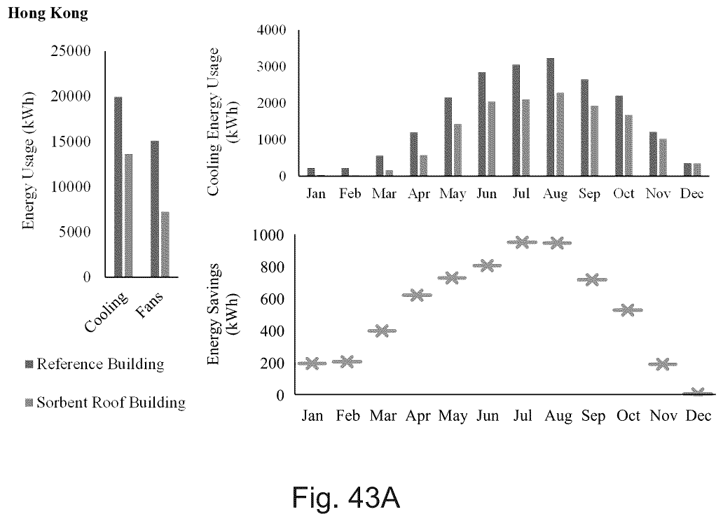

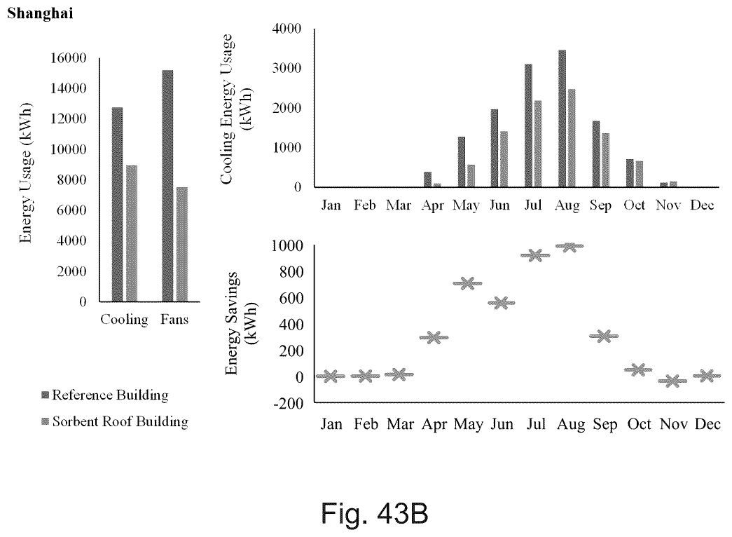

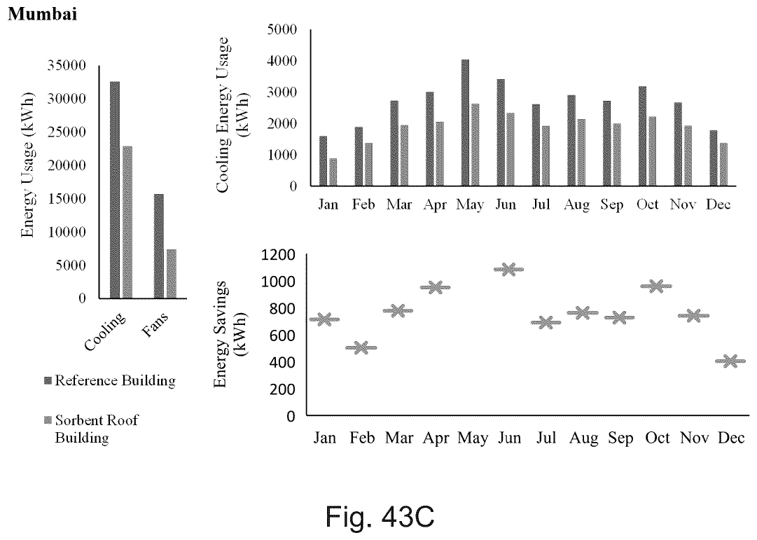

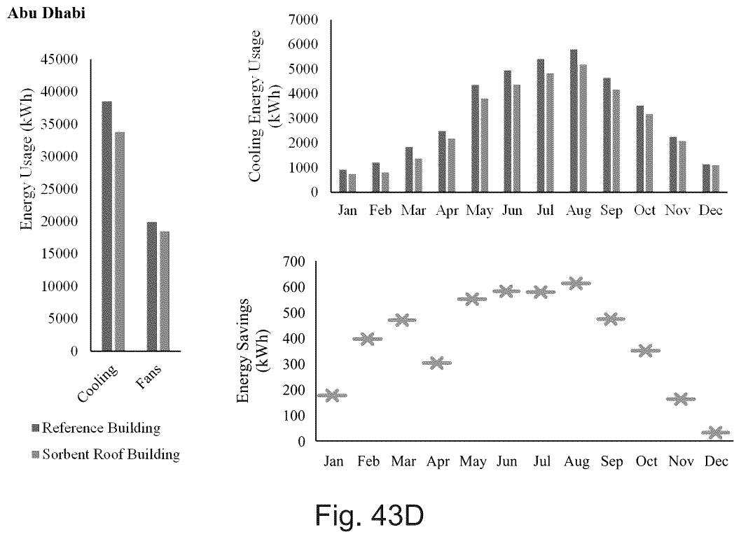

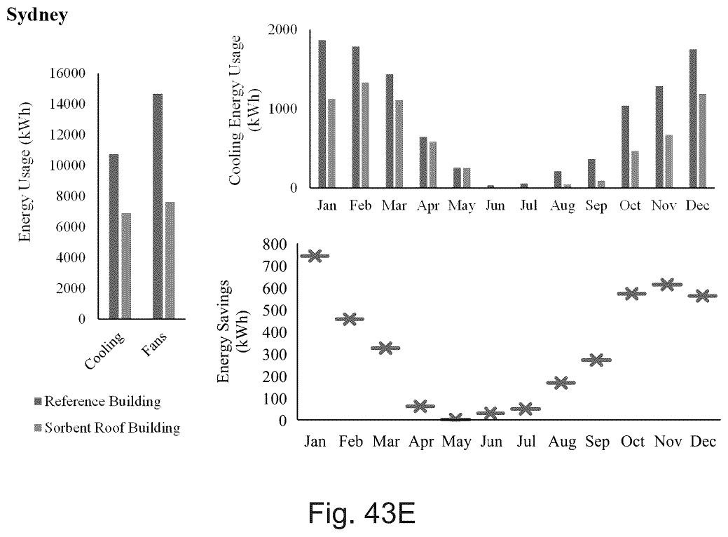

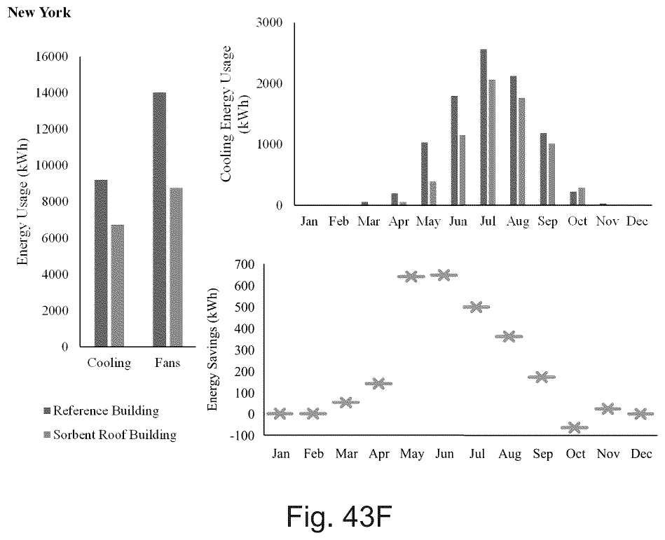

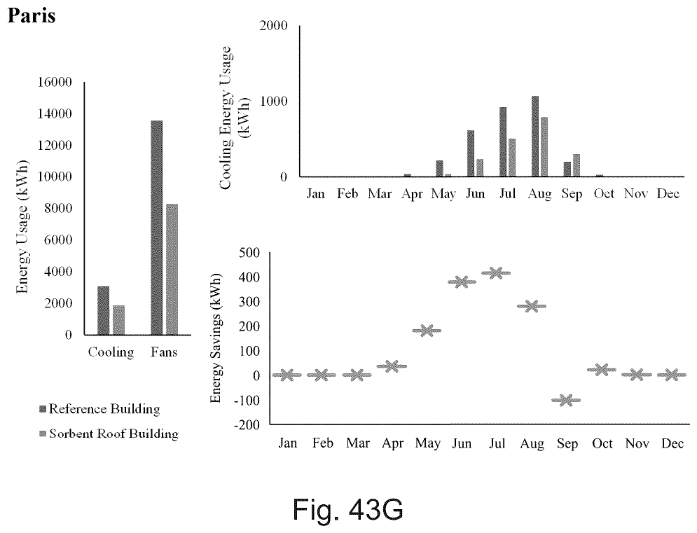

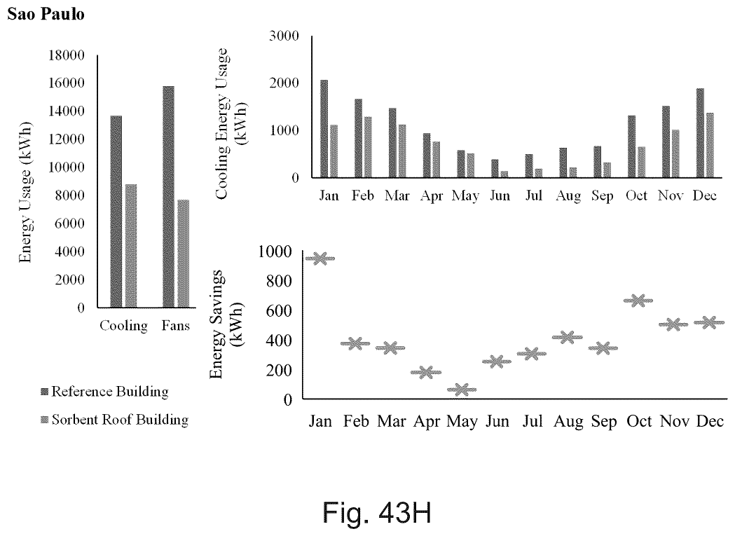

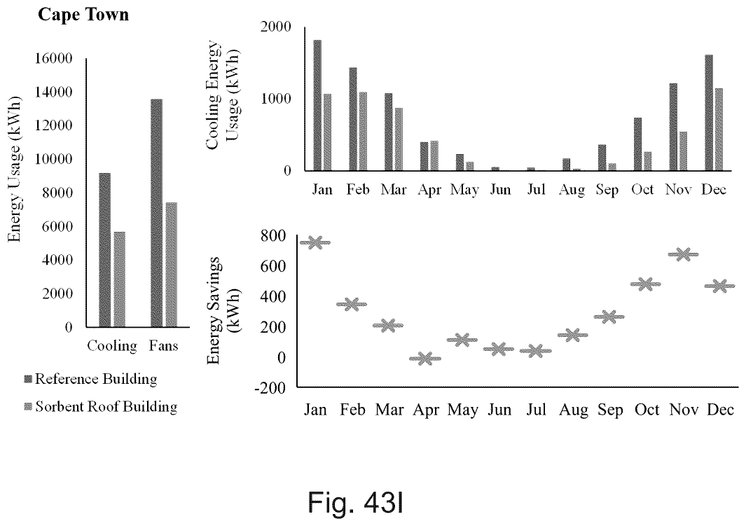

The results of cooling energy usage and energy savings for the reference building and the building with sorbent cooler modelled in EnergyPlus, the carbon footprint of cooling energy used in reference building and the building with sorbent cooler modelled in SimaPro, and carbon dioxide mitigation potential by shifting to sorbent cooling are depicted in FIGS. 41 and 42. The cooling energy use and energy savings annual summary in nine different cities; monthly summary of cooling energy use and energy savings for each city can be seen in FIGS. 43A to 43I. The preliminary results with small-scale building models showed that the sorbent cooler of this work can reduce annual cooling energy use by of 12.16% to 39% compared with predictions for nine cities with different climates. The highest reduction percentage was observed in Abu Dhabi, while Paris showed the lowest reduction percentage.

The difference in percentage is mainly attributed to the varied energy consumption by cooling and fans in different months due to localized weather conditions in different cities. For example, Hong Kong's monthly cooling energy for sorbent roofs ranged from 19.8 to 2285.8 kWh throughout the year, while it ranged from 224.23 to 3230 kWh for reference buildings (FIG. 43A). The annual energy savings varied across the cities, with Hong Kong, Shanghai, Mumbai, Abu Dhabi, Sydney, New York, Paris, Sao Paulo, and Cape Town showing savings of 6269.53 kWh, 3790.99 kWh, 9701.39 kWh, 3848.62 kWh, 3848.62 kWh, 2470.88 kWh, 1205.03 kWh, 4879.29 kWh, and 3478.54 kWh, respectively.

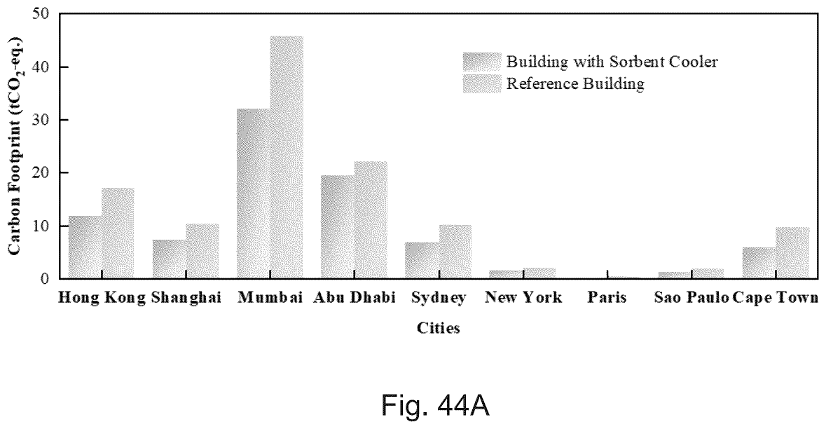

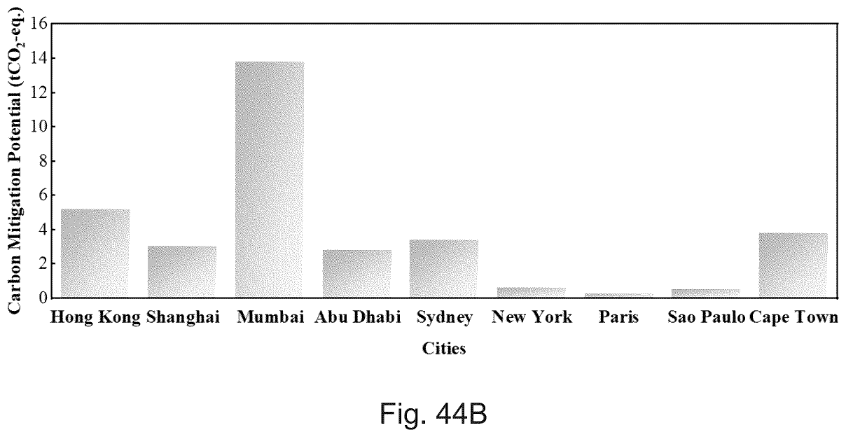

According to FIGS. 44A and 44B, the carbon footprint of cooling energy use in buildings equipped with the sorbent cooling strategy of this work is lower than in reference buildings. The potential annual carbon footprint saving with the sorbent cooler of this work per city ranges from 0.09 to 13.62 tCO₂-eq., which is approximately 61% to 87.83% decrease when compared to emissions released from cooling energy usage in reference building. The carbon mitigation potential varied across the cities, with 5.48 tCO₂-eq. for Hong Kong, 3.24 tCO₂-eq. for Shanghai, 13.62 tCO₂-eq. for Mumbai, 2.70 tCO₂-eq. for Abu Dhabi, 3.73 tCO₂-eq. for Sydney, 0.57 tCO₂-eq. for New York, 0.09 tCO₂-eq. for Paris, 0.69 tCO₂-eq. for Sao Paulo, and 3.73 tCO₂-eq. for Cape Town, respectively. This indicates that the energy consumed by the buildings equipped with sorbent cooling technology emitted lower levels of CO₂ than the reference buildings.

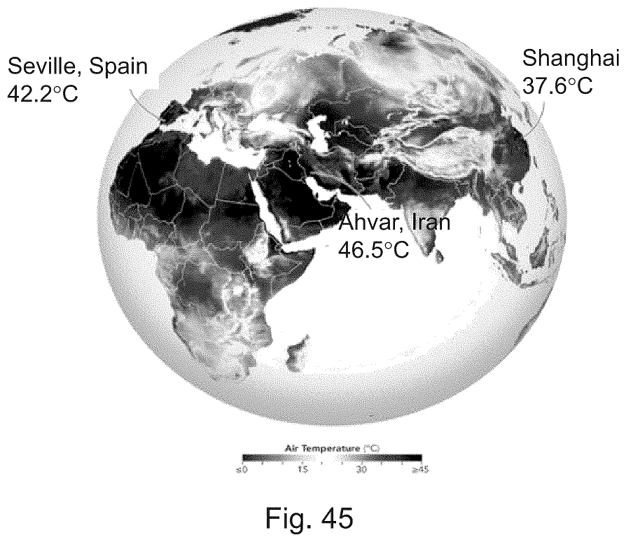

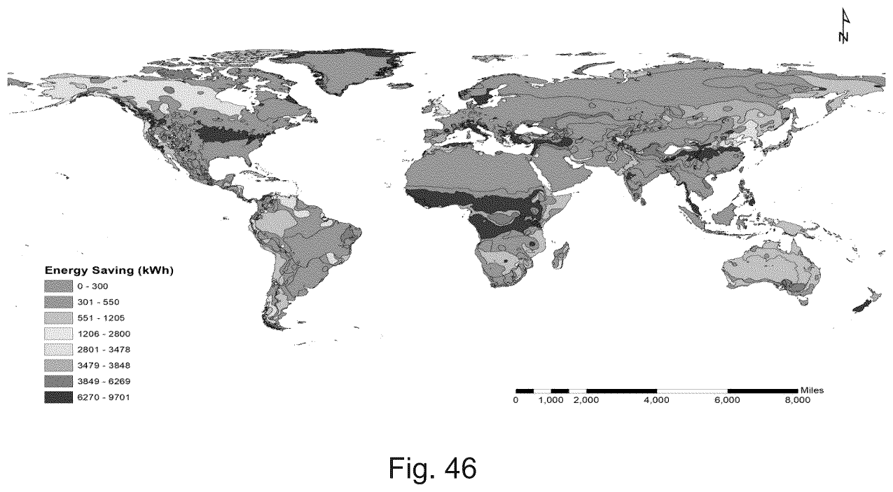

The effectiveness of the sorbent coolers of this work in buildings across different cities was demonstrated, and extensive building energy simulations conducted worldwide to see the potential of this strategy to combat the rising frequency and intensity of heat waves worldwide (FIG. 45), specifically understanding how well this cooling technology performs under varying climatic conditions if integrated into a real-time building. The global simulations revealed the practical applicability of this strategy for annual cooling energy savings, as shown in FIG. 46. The results indicate that sorbent coolers are most effective in climates such as tropical savannas, humid subtropical and tropical and sub-tropical deserts, followed by Mediterranean and western Europe oceanic climates. These findings reveal the energy performance of sorbent coolers and suggest their potential use in specific cities. It is believed that this information can help drive the net energy zero mission in buildings and promote global cooling and sustainability.

The invention has been given by way of example only, and various other modifications of and/or alterations to the described embodiment may be made by persons skilled in the art without departing from the scope of the invention as specified in the appended claims.

1. A composite material for passive cooling comprising a porous structure including an expanded graphite and a surfactant, the porous structure being provided with at least one crystalline deliquescent salt that is selected from the group consisting of chloride, bromide, sulphate, and nitrate.

2. The composite material as claimed in claim 1, wherein the porous structure comprises a scaffold of expanded graphite in which the surfactant and the at least one crystalline deliquescent salt are dispersed.

3. The composite material as claimed in claim 2, wherein the at least one crystalline deliquescent salt is dispersed in micropores of the scaffold of expanded graphite.

4. The composite material as claimed in claim 1 further comprising a moisture-permeable material encapsulating the porous structure.

5. The composite material as claimed in claim 4, wherein the moisture-permeable material is liquid-impermeable.

6. The composite material as claimed in claim 4, wherein the moisture-permeable material is porous and has a pore size of about 3 μm.

7. The composite material as claimed in claim 4, wherein the moisture-permeable material is selected from the group consisting of PTFE, TPU and a combination thereof.

8. The composite material as claimed in claim 1, wherein the surfactant is selected from the group consisting of Triton X-100, IGEPAL CA-630 and a combination thereof.

9. The composite material as claimed in claim 1, wherein the surfactant and the expanded graphite has a mass fraction of about 1:10.

10. The composite material as claimed in claim 1, wherein the at least one crystalline deliquescent salt further comprises a counter cation selected from the group consisting of Li⁺, Na⁺, K⁺, Mg²⁺, Ca²⁺, Sr²⁺, Ba²⁺, Zn²⁺, Au³⁺, NH₄⁺, Fe³⁺, Cu²⁺, Co²⁺, Ni²⁺ and a combination thereof.

11. The composite material as claimed in claim 1, wherein the at least one crystalline deliquescent salt is selected from the group consisting of MgCl₂, CaCl₂, FeCl₃, LiCl, Cu(NO₃)₂, NaNO₃, LiNO₃ ZnSO₄, AuCl₃, NH₄Cl, ZnCl₂, CoCl₂, NiCl₂, SrCl₂, BaCl₂, CuCl₂ and a combination thereof.

12. The composite material as claimed in claim 1, wherein the at least one crystalline deliquescent salt is anhydrous.

13. The composite material as claimed in claim 1 having a density of about 400 kg/m³ to about 600 kg/m³.

14. The composite material as claimed in claim 1 is a sorbent material.

15. A composite sorbent material for passive cooling comprising a porous scaffold of an expanded graphite in which a surfactant and at least one deliquescent salt are dispersed; and a moisture-permeable material encapsulating the porous scaffold; wherein the at least one deliquescent salt is selected from the group consisting of chloride, bromide, sulphate, and nitrate.

16. The composite sorbent material as claimed in claim 15, wherein the at least one deliquescent salt is anhydrous and is provided in crystalline form.

17. The composite sorbent material as claimed in claim 15, wherein the surfactant comprises Triton X-100, the at least one deliquescent salt comprises LiCl, and the moisture-permeable material comprises PTFE.

18. An apparatus for passive cooling comprising:
a housing including an inlet at one end and an outlet at another end;
a plurality of passive cooling units provided within the housing, the plurality of passive cooling units is arranged to define an air passage fluidly connecting the inlet and the outlet;
wherein the plurality of passive cooling units comprises the composite sorbent material as claimed in claim 15.

19. The apparatus as claimed in claim 18, wherein each of the plurality of passive cooling units includes a first end and a second end, and wherein the first end is in closer proximity to a lateral side of the housing with respect to the second end.

20. The apparatus as claimed in claim 19, wherein each of the plurality of passive cooling units is arranged to partially overlap one another.

21. The apparatus as claimed in claim 20, wherein each of the plurality of passive cooling units is arranged in parallel with respect to a vertical plane of the housing.

22. The apparatus as claimed in claim 18, wherein each of the plurality of passive cooling units is configured as a block filled with the composite sorbent material.

23. The apparatus as claimed in claim 22, wherein the block is made of a polymeric material selected from the group consisting of acrylic polymer, polyethylene terephthalate and a combination thereof.

24. The apparatus as claimed in claim 18, wherein the air passage is a winding passage.

25. The apparatus as claimed in claim 18, wherein the housing further includes a plurality of grooves configured to detachably secure the plurality of passive cooling units.

26. The apparatus as claimed in claim 18, wherein the housing further includes a ventilation unit operably connected to the inlet, thereby allowing air to be drawn into the apparatus.

27. The apparatus as claimed in claim 26, wherein the ventilation unit is a fan having a driving power substantially lower than cooling power of the apparatus.

28. The apparatus as claimed in claim 26, wherein the inlet and the outlet are arranged on the same lateral side of the housing.
